(19) United States
(12) Patent Application Publication
(10) Pub. No.: US 2011/0229300 A1
(43) Pub. Date: Sep. 22, 2011

(54) APPARATUS AND METHOD FOR INDIVIDUAL PITCH CONTROL IN WIND TURBINES

(75) Inventors: S.K. KANEV, Petten (NL); Jan Schuurmans, Petten (NL); Timotheus Gerardus VAN ENGELEN, Petten (NL)

(73) Assignee: STICHTING ENERGIEONDERZOEK CENTRUM NEDERLAND, Petten (NL)

(21) Appl. No.: 12/724,803

(22) Filed: Mar. 16, 2010

(51) Int. Cl. F03D 7/04; F01D 7/02

(52) U.S. Cl. 415/1; 415/33; 416/44; 416/43

(57) ABSTRACT

In a method for blade load reduction control of a rotor of a wind turbine, the rotor includes a plurality of blades, and a pitch angle of each blade is controllable by an actuator. The method includes measuring mechanical load parameters on the rotor, providing control for a collective pitch blade setting based on a rotor speed; providing individual pitch control including transforming the mechanical load parameters from a rotational reference frame to a mechanical load on the rotor in a fixed reference frame; determining from the mechanical load two multi-blade pitches; correcting the multi-blade pitches to corrected multi-blade pitches using actuator limitations; inversely transforming the corrected multi-blade pitches to an individual pitch deviation for each blade in the rotational reference frame; adding up for each blade, the individual pitch deviation to the collective pitch to form an individual pitch; and setting each blade to the respective individual pitch.

### FIELD

The present invention relates to an apparatus for individual pitch control in wind turbines. Also, the present invention relates to a method for individual pitch control in wind turbines.

Modern wind turbines have the possibility of individually pitching the blades, opening the road towards the use of advanced individual pitch control (IPC) algorithms for achieving fatigue load reduction. Different effects (e.g. tower shadow, wind shear, yaw misalignment, and rotational wind field sampling) result in blade loads at the rotational frequency (1 p) and multiples of it (1 p, 2 p, 3 p, etc.). Blade load reduction by IPC can be achieved by using additional measurements, such as blade root bending moments, shaft bending moments, or tower-top bending moments measured at the yaw bearing. Using blade root bending moments measurements with which modern wind turbines are often equipped, gives rise to a periodic system which complicates the IPC design. This problem can fortunately be circumvented by transforming all quantities (pitch angles, blade moments, etc.), defined on the rotating reference frame, to the fixed frame by using the so-called Coleman transformation [10], which results in a linear time-invariant (LTI) model. The blade root flapwise bending moments, for instance, are transformed into rotor tilt and yaw moments, which are used by the IPC to compute tilt-oriented and yaw-oriented pitch signals. Thus the Coleman transformation makes the application of well-developed control theory for LTI systems to the IPC problem possible. In addition, the treatment in fixed-frame coordinates allows for the decoupling of the collective pitch control (CPC) design from the IPC design because of negligible interaction in the relevant frequencies.

The use of IPC for 1 p blade load reduction has received attention in the literature lately [3, 4, 1], where the conventional approach aims at static rotor tilt and yaw moments reduction by using integral-type control. These rotor moments can either be measured directly (e.g. at the yaw bearing), or can be reconstructed from measured blade root (or shaft) bending moments. The IPC computes so-called tilt and yaw oriented blade pitch signals which are then demodulated by the inverse Coleman transformation into three individual blade pitch angles. In this way, the IPC adds almost-periodical blade pitch angle variations at the 1 p frequency to the collective blade pitch angle. Modern control can be used for the synthesis of more complex IPC controllers for 2 p (and higher) blade load reduction [3, 4, 7, 5].

Differences in the profile properties of rotor blades, as well as in the blade pitch setting angles, during assemblage lead to aerodynamic unbalance. Moreover, inaccuracies in the mass properties during assemblage lead to mass unbalance. During operation in cold climates, ice formation can have similar effects. Neglecting such unbalance can severely degrade the performance of the IPC load reduction algorithm. A novel IPC algorithm is proposed that achieves rotor balancing by pitching the blades to some quasi-static pitch angles (different for each blade) in such a way, that the static shaft loads are mitigated.

Bringing modern IPC algorithms into practice necessitates the consideration of the actuator limitations, expressed as position, velocity and acceleration constraints on the blade pitch signals. Due to the intrinsic integral type of the IPC algorithms, anti-windup schemes must be implemented to avoid instability. As a second contribution of the paper, anti-windup IPC scheme is developed. To this end, the original pitch actuator limits are transformed into constraints on the IPC tilt and yaw-oriented pitch signals. This is performed in such a way that the IPC for blade load reduction uses only the actuation freedom that is not used up by the CPC algorithm and the IPC rotor balancing algorithm, achieving proper overall operation under the given blade pitch actuator limits.

The proposed IPC algorithms and anti-windup schemes are demonstrated on nonlinear simulations, consisting of a detailed structural dynamics model generated with the software Turbu [10], nonlinear blade momentum (BEM) aerodynamics (including dynamic wake effects and oblique inflow modeling), as well as realistic blade-element effective wind speeds, modeling wind shear, tower shadow, tilt and yaw misalignment, wind gusts and stochastic turbulence.

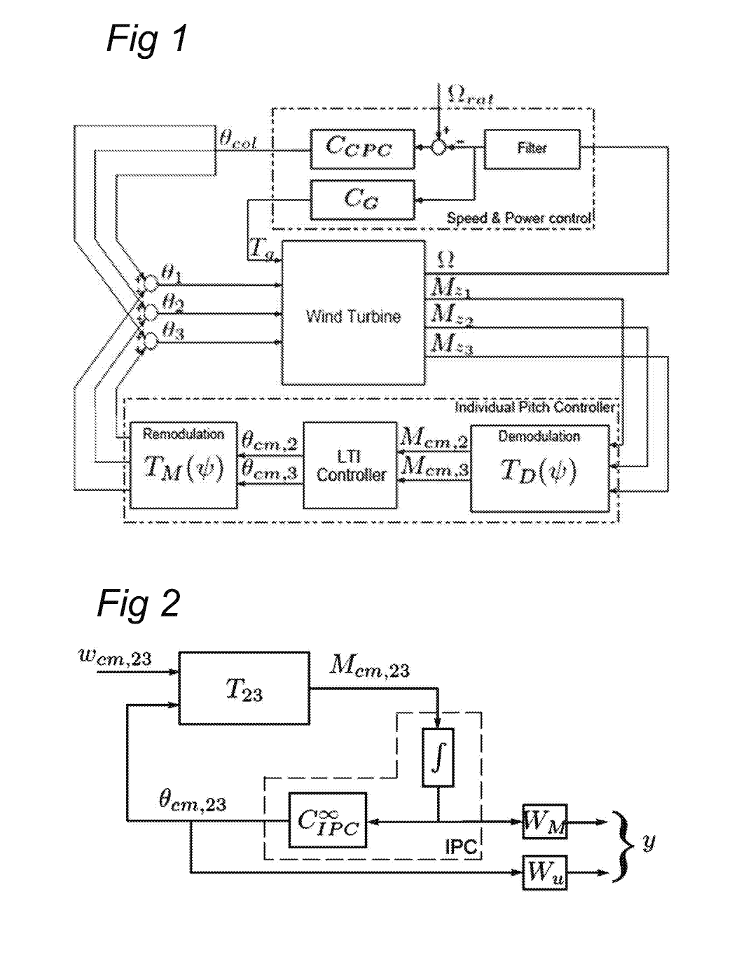

FIG. 1 shows a schematic for wind turbine individual pitch control.

In the overall structure of FIG. 1 a wind turbine WT is operatively coupled to a speed and power control unit which comprises a CPC controller (CPC: collective pitch control) and a C_{G}, generator torque controller. The speed and power control unit is arranged to receive a value Ω of the rotor speed from the wind turbine. Further, the CPC controller is arranged to generate a collective blade setting θ_{col} for the blades of the rotor of the wind turbine.

Further, wind turbine WT is operatively coupled to an IPC controller which comprises a LTI controller, a Coleman demodulation unit T_{D}(ψ) and a retransformation unit T_{M}(ψ).

The Coleman demodulation unit T_{D}(ψ) is operatively coupled to the LTI controller, and the LTI controller is operatively coupled to the retransformation unit T_{M}(ψ). The Coleman demodulation unit is arranged to receive as input a blade moment Mz1, MZ2, Mz3 at each blade of the wind turbine from the respective sensor coupled to the respective blade and to apply a transformation to static yaw and tilt moments as described above from a blade load.

The Coleman demodulation unit T_{D}(ψ) is for example arranged for transformation from 1 p blade loads. Each LTI controller is arranged to receive as derived by the associated Coleman demodulation unit for the respective 1 p blade load and to reduce those static yaw and tilt moments of the overall load for the respective 1 p blade load by adjusting yaw and pitch angles for the total rotor.

Further the LTI controller is arranged to transmit the adjusted yaw and pitch values to the retransformation unit.

The retransformation unit is arranged to inversely transform (with relation to the Coleman demodulation) the adjusted yaw and pitch angles back into individual blade angles for each individual blade of the rotor in relation to the blade load.

Finally, the values of the blade angles are recombined and summed with the collective blade setting θ_{col} to obtain individual blade angle settings for each blade of the rotor, wherein each blade angle setting is adapted for the 1 p frequency dependency of the blade load.

Below, a discussion is given relating to some IPC algorithms for blade load reduction, paying attention to both conventional I-type and advanced H∞ control design. The starting point is the closed-loop interconnection, depicted on FIG. 1, where C_{CPC} denotes the CPC algorithm, and C_{G} is the generator torque controller. The design of these basic controllers, C_{CPC} and CG, is known from the prior art. For an overview of basic wind turbine control, refer to [2, 9].

The IPC controller for blade load reduction can be based on different measurements, though here we will assume the availability blade root bending moments measurements since these are common in modern wind turbines. The use of other measurements (e.g. moments at the shaft or at the yaw bearing) is straightforward. Suppose the following linear parameter varying model describes the relevant dynamics of the wind turbine (possibly including the basic controllers C_{CPC} and C_{G}) from the three blade pitch angles θᵢ, and axial blade effective wind speeds wᵢ, to the three flapwise blade root bending moments

M_{z}_{ᵢ}, i=1, 2, 3

\dot{x}(t)=A(ψ, p)x(t)+B(ψ, p)θ(t)+E(ψ, p)w(t)

M_{z}(t)=C(ψ, p)x(t)+D(ψ, p)θ(t)+F(ψ, p)w(t) (1)

where ψ is the rotor azimuth angle,

M_{z}=[M_{z}_{₁}(t)M_{z}_{₂}(t)M_{z}_{₃}(t)]^{T},

θ=[θ₁(t)θ₂(t)θ₃(t)]^{T},

w=[w₁(t)w₂(t)w₃(t)]^{T}

and the parameter p={Ω, θ_{col}, wₐₓ} defines the operating point of the turbine, depending on the rotor speed, the collective blade pitch angle θ_{col}=1/3(θ₁+θ₂θ₃), and the driving torque effective wind speed w_{dr}=1/3(w₁+w₂+w₃). Although not explicitly denoted in the model, the parameters ψ=ψ(t) and p=p(t) are functions of time. The blade-effective wind speeds wᵢ are fictitious signals defined in such a way, that they approximate (in statistical sense) the effects of full 3D longitudinal turbulence on the driving moments of the three blades [12].

Notice that for a fixed operating point p(t)=p*, above model represents a periodic system, which complicates the controller design process. However, by transforming the signals Mz, θ and w (and states x) to the fixed rotor reference frame, one can convert this model into an LTI system. This so-called Coleman transformation, is based on the matrix

$${T}_{D} ( ψ ) = [ \begin{matrix}\frac{1}{3} & \frac{1}{3} & \frac{1}{3} \\ \frac{2}{3} sin ( ψ ) & \frac{2}{3} sin ( ψ + \frac{2 π}{3} ) & \frac{2}{3} sin ( ψ + \frac{4 π}{3} ) \\ \frac{2}{3} cos ( ψ ) & \frac{2}{3} cos ( ψ + \frac{2 π}{3} ) & \frac{2}{3} cos ( ψ + \frac{4 π}{3} )\end{matrix} ] \qquad ( 2 )$$

which is used to demodulate the signals defined in the rotating coordinate frame into non-rotating multi-blade coordinates (indexed cm, i)

$$[ \begin{matrix}{M}_{cm , 1} & {θ}_{cm , 1} & {w}_{cm , 1} \\ {M}_{cm , 2} & {θ}_{cm , 2} & {w}_{cm , 2} \\ {M}_{cm , 3} & {θ}_{cm , 3} & {w}_{cm , 3}\end{matrix} ] = {T}_{D} ( {ψ}_{k} ) [ \begin{matrix}{M}_{z , 1} & {θ}_{1} & {w}_{1} \\ {M}_{z , 2} & {θ}_{2} & {w}_{2} \\ {M}_{z , 3} & {θ}_{3} & {w}_{3}\end{matrix} ]$$

It has been shown in [10, 11] that this transformation gives an LTI model in multi-blade coordinates)

\dot{x}_{cm}=A_{cm}(p)x_{cm}+B_{cm}(p)θ_{cm}+E_{cm}(p)w_{cm}

M_{cm}=C_{cm}(p)x_{cm}+D_{cm}(p)θ_{cm}+F_{cm}(p)w_{cm} (3)

which takes the form of an LTI for a fixed operating point (i.e. for fixed p), allowing the use of conventional control design techniques. The resulting IPC should then be connected to the original system using the Coleman demodulation matrix (2) and its inverse:

$${T}_{M} ( ψ ) = [ \begin{matrix}1 & sin ( ψ ) & cos ( ψ ) \\ 1 & sin ( ψ + \frac{2 π}{3} ) & cos ( ψ + \frac{2 π}{3} ) \\ 1 & sin ( ψ + \frac{4 π}{3} ) & cos ( ψ + \frac{4 π}{3} )\end{matrix} ] .$$

The first multi-blade coordinate represents averaging over the blades. In other words, θ_{cm,1}≡θ_{col} is the collective pitch angle, w_{cm,1}≡w_{dr} is the rotor-averaged axial wind speed. By actuating θ_{cm,2} and θ_{cm,3}, the IPC controller adds up deviations around the collective pitch angle θ_{col}, which is controlled by the CPC (see FIG. 1). Moreover, it can be shown that the rotor tilt and yaw moments are approximately proportional to the second and third multi-blade co-ordinates of the blade root flapwise moments. More specifically, when the influence of tensile and shearing forces and pitch-wise moments in the hub center are neglected, Mₜᵢₗₜ=3/2 M_{cm,2} and M_{yaw}=3/2 M_{cm,3}.

For that reason, the second multi-blade components of the input signals, θ_{cm,2} and w_{cm,2}, are referred to as tilt-oriented components (having mostly effect on the rotor tilt moment), while the θ_{cm,3} and w_{cm,3} are called yaw-oriented components.

Finally, it should be pointed out that, due to rotational wind field sampling, tower shadow, and wind shear, the original blade effective wind speeds wᵢ contain frequency components at multiples of the rotational frequency, i.e. 1 p, 2 p, etc. This results in similar (n.p) components in the blade root moments M_{zi}. In multi-blade coordinates, however, these n.p frequencies in wᵢ are demodulated into 3.n.p frequencies in w_{cm,2} and w_{cm,3}, resulting in 3 p, 6 p, 9 p, etc., components in M_{cm,2} and M_{cm,3}. More specifically, 1 p components in M_{z} are transformed into static 0 p tilt and yaw moments, {2 p, 4 p} frequencies in M_{z} become 3 p components in the fixed frame, {5 p, 7 p} are modulated to 6 p, and so on. Interestingly, 3.n.p components in the flap moments cancel out and have no influence on the rotor moments. For more inside into the effects of the Coleman transformation, see [10].

As explained above, 1 p blade load reduction can be achieved by means of reducing the static (0 p) rotor moments M_{cm,2} and M_{cm,3}. Due to the negligible coupling between these at low frequencies, a SISO approach with two simple I-compensators is sufficient:

$${θ}_{cm , 2} = \frac{{k}_{2}}{s} {F}_{IPC} ( s ) {M}_{cm , 2} , \\ {θ}_{cm , 3} = \frac{{k}_{3}}{s} {F}_{IPC} ( s ) {M}_{cm , 3} , \qquad ( 4 )$$

Where F_{IPC}(s) is series of band-stop filters around the 3 p and 6 p frequencies that prevents unnecessary propagation of these components in M_{cm} into the multi-blade pitch angles. A filter at the first tower frequency might also be needed. At steady state, θ_{cm,2} and θ_{cm,3} will converge to some static values, which after modulation to rotating coordinates, yield cyclic variations of the three blade pitch angles around θ_{col}, shifted by 120°:

$${θ}_{i} = {θ}_{col} + sin ( ψ + \frac{( i - 1 ) 2 π}{3} ) {θ}_{cm , 2} + cos ( ψ + \frac{( i - 1 ) 2 π}{3} ) {θ}_{cm , 3}$$

The gains k₂ and k₃ can be selected to achieve some desired gain margin m_{g} (e.g. m_{g}=2). The phase margin cannot be influenced with kⱼ. To this end, denote Tⱼ(s), j=2, 3, as the transfer function from θ_{cm,j} to M_{cm,j} in (3), and consider the open-loop transfer

$${L}_{j} ( s ) = \frac{{k}_{2}}{s} {F}_{IPC} ( s ) {T}_{j} ( s ) .$$

Due to the lack of poles of L(s) in the open right-half plane, a standard Nyquist stability analysis can be applied to compute kⱼ, i.e.,

$${k}_{j} = \frac{1}{{m}_{g} \vert {T}_{j} ( {ω}_{180 °} ) \vert}$$

where ω_{180°} is such that ∠(Tⱼ(ω_{180°}))=180°.

Although the SISO IPC approach above works well in practice, its stability should be analyzed carefully due to the neglected coupling between the two considered channels.

These limitations can be removed by using more complex control structures, based on modern multivariable control synthesis methods. In fact, modern control design can also be used to achieve mitigation of blade loads at frequencies higher than 1 p (i.e. 2 p and higher), although this will not be pursued in this paper. Higher harmonics control gives rise to 2 p and higher components in the blade pitch angles θᵢ, leading easily to unrealistic actuation demands.

The goal here is to design a stabilizing controller that minimizes the low frequency components of the rotor moments' signals M_{cm,2} and M_{cm,3}. In order to achieve zero steady state rotor moments, an integral action will be included in the controller. Furthermore, as was also the case with the simple I-compensator above, the controller should not be active at the 3 p, the 6 p, and possibly the first tower frequency. In addition to that, no high frequency control activity is desired. To achieve these performance specifications, an H∞-optimal controller with integral action can be designed, based on the MIMO transfer function T₂₃ from the external inputs w_{cm,23}=[w_{cm,2}, w_{cm,3}]^{T} and control action θ_{cm,23}=[θ_{cm,2}, θ_{cm,3}]^{T} to the rotor moments M_{cm,23}=[M_{cm,2}, M_{cm,3]}^{T}.

FIG. 2 provides an block-schematic view of the IPC design model. In order to include integral action into the controller, the output of the system T₂₃ is appended with integrators (one integrator per output), which integrated model is used for an optimal H∞ controller design C∞. The final controller is constructed by IPC moving the integrators, used in the design model, to the inputs of the computed controller (see the area inside the dashed curve on FIG. 2). In order to comply with the frequency domain design specifications, the controller C∞ is designed by minimizing IPC the H∞ norm of the closed-loop transfer from the external inputs w_{cm,23} to the weighted integrated rotor moments and weighted control signals, as shown in FIG. 2 (see the generalized output signal y). The weighting function Wᵤ should be selected to punish control activity at 3 p, the 6 p, first tower and higher frequencies. The weighting function W_{M}, on the other hand, needs to put a frequency domain weighting on the integrated rotor moments. As there is integral action in the controller anyway, the lower frequencies need not to be weighted additionally. Instead, W_{M} could put additional weighting on low frequencies as in [8].

The H∞ controller is computed for the augmented model T₂₃^{aug}

$$[ \begin{matrix}y \\ {M}_{cm , 23}\end{matrix} ] = {T}_{23}^{aug} [ \begin{matrix}{w}_{cm , 23} \\ {θ}_{cm , 23}\end{matrix} ] , \\ {T}_{23}^{aug} = [ \begin{matrix}[ \begin{matrix}0 & {W}_{u} ( s )\end{matrix} ] \\ \frac{1}{s} {W}_{M} ( s ) {T}_{23} ( s ) \\ {T}_{23} ( s )\end{matrix} ]$$

via the following optimization problem [13]

$${C}_{IPC}^{∞} = arg {min}_{K} ‖ ℱ ( {T}_{23}^{aug} ( s ) , K ( s ) ‖ ∞ ,$$

where F(T₂₃^{aug}(s), K(s)) denotes the closed-loop system, ∥·∥∞ denotes the H∞ system norm, and wherein the optimization is defined over all controllers K(s) that have the same number of states as the augmented model T₂₃^{aug}(s). Moving the integrators back to the controller results in the final IPC

$${C}_{IPC} ( s ) = [ \begin{matrix}\frac{1}{s} & \\ & \frac{1}{s}\end{matrix} ] {C}_{IPC}^{∞} ( s ) . \qquad ( 5 )$$

The IPC controllers, presented above, are based on a linearized turbine model, and will thus only achieve the specified design criteria at the working point where the model is valid. To achieve improved performance throughout the whole operation range of the turbine, a gain-scheduling approach can be used. As the IPC control is only to be active in above-rated wind conditions, the operating point is (statically) defined by θ_{col}. Hence, the gain of the IPC controller can be scheduled as a function of the collective pitch angle in such a way that the DC gain of the resulting open-loop transfer function remains constant. More specifically, suppose that the IPC controller CIPC(s) is de-signed based on the model T₂₃^{aug}(s), linearised around some given operating point

p*={Ωᵣₐₜ, θ*_{col}, w*_{dr}},

defined by θ*_{col}, and let T₂₃^{l}(s), 1=1, 2, . . . , L, denote linearisations of the dynamics from θ_{cm,23} to M_{cm,23} around operating points with corresponding θ_{col}^{l}. By computing off-line the gain matrices

K_{gs}^{l}=T₂₃(0)·(T₂₃^{l}(0))⁻¹, 1=1, 2, . . . , L

one can gain-schedule the IPC controller based on the current collective pitch angle θ_{col}(t) as follows

$$j = \{ l \text{:} l = 1 , … , L , {θ}_{col}^{l} \leq {θ}_{col} ( t ) \leq {θ}_{col}^{l + 1} \} , \\ α ( t ) = \frac{{θ}_{col} - {θ}_{col}^{j}}{{θ}^{j + 1} - {θ}_{col}^{j}} , \\ {\tilde{C}}_{IPC} ( s ) = {C}_{IPC} ( s ) ( α ( t ) {K}_{gs}^{l + 1} + ( 1 - α ( t ) ) {K}_{gs}^{l} ) .$$

Rotor unbalance is caused by different aerodynamic conversion properties of the individual blades, and by mass distribution differences between the blades. Figure shows a schematic wind turbine representation.

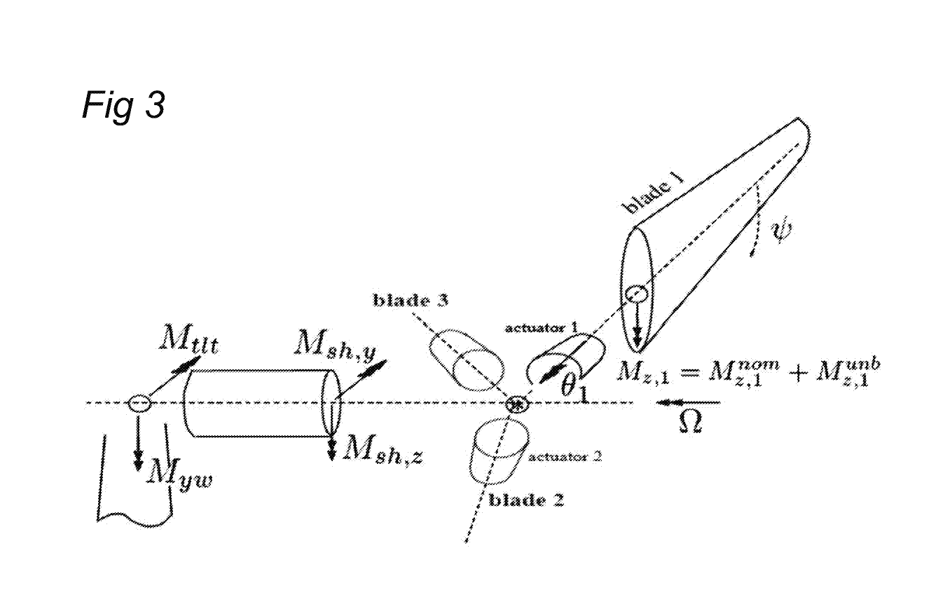

In FIG. 3, the unbalance is represented by the extra term M_{z,j}^{unb} added to the nominal M_{t,j}^{nom} blade moment. The terms M_{z,j}^{unb}, i=1, 2, 3 have unequal non-zero mean values that usually vary slowly. This unbalance causes nearly constant bending moment coordinates M_{sh,y} and M_{sh,z} on the rotor shaft. These induce variations in the tower-top moments Mₜₗₜ and M_{yaw} around the 1 p frequency. These 1 p variations can severely tamper with the IPC blade load reduction algorithm as they get demodulated into 2 p pitch angle variations. This results in additional 2 p loads in the flap moments and 3 p loads in the tower top moments. The bending moment in the rotor shaft is the unbalance-identifying quantity, and the compensation scheme below is based on the two shaft moment coordinates M_{sh,y} and M_{sh,z}, cause by the blade flap moments:

$$[ \begin{matrix}{M}_{sh , y} \\ {M}_{sh , z}\end{matrix} ] = {\underbrace{[ \begin{matrix}- sin 0 & - sin \frac{2}{3} π & - sin \frac{4}{3} π \\ cos 0 & cos \frac{2}{3} π & cos \frac{4}{3} π\end{matrix} ]}}_{{T}_{D}^{zh}} [ \begin{matrix}{M}_{z , 1} \\ {M}_{z , 2} \\ {M}_{z , 3}\end{matrix} ] .$$

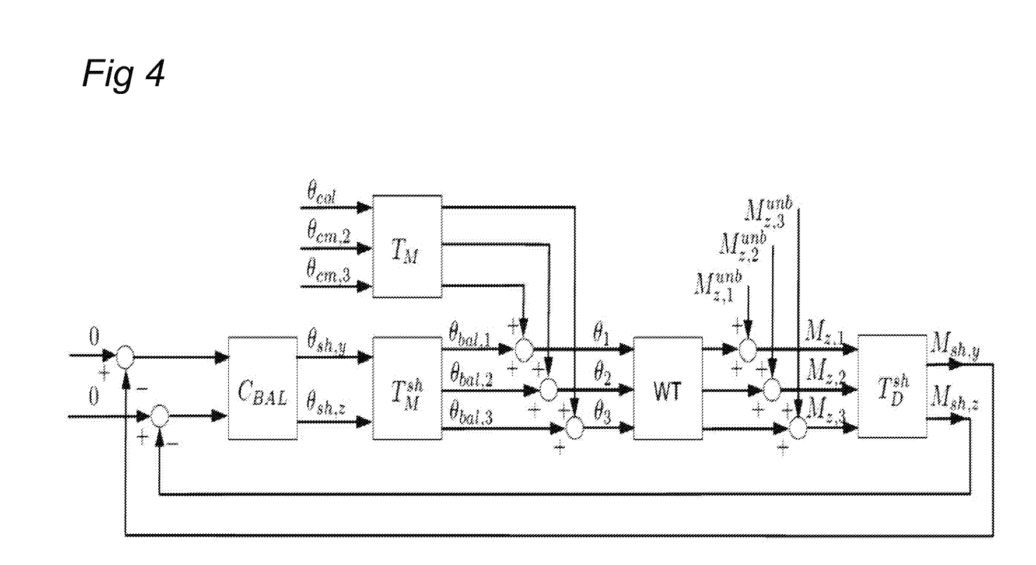

FIG. 4 shows a rotor balancing IPC loop, i.e., the linearized closed-loop configuration for the IPC unbalance compensation loop (patent application filed, August 2008). The shaft moment co-ordinates M_{sh,y} and M_{sh,z} are first mapped to virtual pitch angle variations θ_{sh,y} and θ_{sh,z} along the shaft unit vectors, and then are transformed back to actual pitch angle variations

$$[ \begin{matrix}{θ}_{bal , 1} \\ {θ}_{bal , 2} \\ {θ}_{bal , 3}\end{matrix} ] = {T}_{M}^{sh} [ \begin{matrix}{θ}_{sh , y} \\ {θ}_{sh , z}\end{matrix} ] , \\ {T}_{M}^{sh} = \frac{2}{3} [ \begin{matrix}- sin 0 & cos 0 \\ - sin \frac{2}{3} π & cos \frac{2}{3} π \\ - sin \frac{4}{3} π & cos \frac{4}{3} π\end{matrix} ] ,$$

which are added to the blade pitch angle variations from the CPC and IPC blade load reduction algorithm.

To design the balancing controller C_{BAL}, the wind turbine model from θ_{sh,y} and θ_{sh,z} to M_{sh,y} and M_{sh,z} is needed. The transfer from θᵢ to M_{z,i} is azimuth-dependent (see (1)). However, at low frequencies (typically below 0.1 Hz), the model can be approximated by a static, azimuth-independent and diagonal with the same gain for the two channels, i.e. M_{sh,y}≈kθ_{sh,y} and M_{sh,z}≈kθ_{sh,z}. For such a low bandwidth, the phase is negligible. This allows the use of a simple controller structure, consisting of a first-order low-pass filter and integral action

$$[ \begin{matrix}{θ}_{sh , y} \\ {θ}_{sh , z}\end{matrix} ] = \frac{{c}_{0}}{s} \frac{1}{τ s + 1} [ \begin{matrix}{M}_{sh , y} \\ {M}_{sh , z}\end{matrix} ] ,$$

giving closed-loop disturbance rejection

$$\begin{matrix}{T}_{sh}^{cl} ( s ) = \frac{1}{1 + k \frac{{c}_{0}}{s} \frac{1}{τ s + 1}} \\ = \frac{\frac{τ {s}^{2}}{{kc}_{0}} + \frac{s}{{kc}_{0}}}{\frac{τ {s}^{2}}{{kc}_{0}} + \frac{s}{{kc}_{0}} + 1} .\end{matrix}$$

The controller parameters c₀ and τ are then chosen to yield a critically damped desired closed-loop system (β=1) with given settling time Tₛₑₜ (e.g. 50 sec)

$${T}_{sh}^{cl , desired} ( s ) = \frac{\frac{1}{{ω}^{2}} {s}^{2} + \frac{2 β}{{ω}_{0}} s}{\frac{1}{{ω}^{2}} {s}^{2} + \frac{2 β}{{ω}_{0}} s + 1} , \\ with ω = \frac{4}{{T}_{set} β} .$$

This is achieved with

$$τ = \frac{{T}_{set}}{8} , \\ {c}_{0} = \frac{2}{k {β}^{2} {T}_{set}} .$$

The pitch actuators in wind turbines have limits, and it is crucial that these limits are properly taken care of in the control algorithm. This is especially important for controllers with integral terms, as is the case with the discussed IPC algorithms above, as otherwise the well-known windup effect can occur, resulting in degraded performance or even instability. In this section, it is shown how anti-windup can be achieved for the IPC algorithm. Implementation of anti-windup scheme for the CPC algorithm is just as important, but less involved.

Since the IPC algorithm is defined in the non-rotating reference frame, the original blade pitch angle, speed and acceleration limits need to be translated to multi-blade coordinates before an anti-windup scheme can be applied. Moreover, in order to make sure that the IPC algorithm does not tamper with the CPC, it should only use the actuation freedom that is not used up by the CPC (and the rotor balancing IPC). In this way, proper simultaneous operation of all control algorithms is achieved, with priority to CPC.

The following positions, speeds and accelerations hard limits are considered for the blade actuators, i=1, 2, 3,

θₘᵢₙ≦θᵢ≦θₘₐₓ,

\dot{θ}ₘᵢₙ≦\dot{θ}ᵢ≦\dot{θ}ₘₐₓ,

\ddot{θ}ₘᵢₙ≦\ddot{θ}ᵢ≦\ddot{θ}ₘₐₓ, (6)

where the minimum and maximum values are assumed given. Part of this total actuation freedom is attributed to the basic CPC algorithm and the rotor balancing IPC, and it is assumed that the following limits are met at all time

θₘᵢₙ≦θₘᵢₙ^{col}≦θ_{col}≦θₘₐₓ^{col}≦θₘₐₓ,

\dot{θ}ₘᵢₙ<\dot{θ}ₘᵢₙ^{col}≦\dot{θ}_{col}≦\dot{θ}ₘₐₓ^{col}<\dot{θ}ₘₐₓ,

\ddot{θ}ₘᵢₙ<\ddot{θ}ₘᵢₙ^{col}≦\ddot{θ}_{col}≦\ddot{θ}ₘₐₓ^{col}<\ddot{θ}ₘₐₓ, (7)

Notice that the speed and acceleration constraints for the CPC action are chosen strictly inside the actuator limits, hence always leaving some freedom for the IPC controller. For the pitch angle it is not always possible to select θₘᵢₙ<θ_{col} strictly, as would be the case when the lower pitch angle bound θₘᵢₙ coincides with the working position at below-rated conditions (which should be reachable by θ_{col}).

Defining

$${ψ}_{i} ≐ {ψ}_{k} = \frac{2 π ( i - 1 )}{3}$$

as the azimuth angle of blade I, we can then write

θᵢ=θ_{col}+sin(ψᵢ)θ_{cm,2}+cos(ψᵢ)ν_{cm,3}, i=1, 2, 3.

Clearly, the IPC actions θ_{cm,2} and θ_{cm,3} have effect on all three blade angles, speeds and accelerations. Still, they should not lead to the original actuator limits (6) getting exceeded. To achieve this, limits on the IPC actions θ_{cm,2} and θ_{cm,3} will be derived for which (6) remain valid. It is desirable that these limits do not (explicitly) depend on the rotor azimuth ψₖ. To this end, the remaining freedom in the actuators after the CPC controller will be distributed among the two IPC controls. Define

θ^{rest}\dot{=}max{0, min{θₘₐₓ−θ_{col}, θ_{col}−θₘᵢₙ}},

\dot{θ}^{rest}\dot{=}max{0, min{\dot{θ}ₘₐₓ−\dot{θ}_{col}, \dot{θ}_{col}−\dot{θ}ₘᵢₙ}},

\ddot{θ}^{rest}\dot{=}max{0, min{\ddot{θ}ₘₐₓ−\ddot{θ}_{col}, \ddot{θ}_{col}−\ddot{θ}ₘᵢₙ}},

where the current collective pitch speed \dot{θ}_{col} and acceleration \ddot{θ}_{col} should be substituted by their finite difference approximations.

Denoting

J(ψ, θ_{cm,2}, θ_{cm,3})\dot{=}sin(ψ)θ_{cm,2}+cos(ψ)θ_{cm,3},

the purpose of this section is to derive limits on the IPC angles θ_{cm,2} and θ_{cm,3}, as well as on their speeds and accelerations, such that for any ψ the following inequalities are satisfied

$$\vert [ \begin{matrix}J ( ψ , {θ}_{cm , 2} , {θ}_{cm , 3} ) \\ \dot{J} ( ψ , {θ}_{cm , 2} , {θ}_{cm , 3} ) \\ \ddot{J} ( ψ , {θ}_{cm , 2} , {θ}_{cm , 3} )\end{matrix} ] \vert \leq [ \begin{matrix}{θ}^{rest} \\ {\dot{θ}}^{rest} \\ {\ddot{θ}}^{rest}\end{matrix} ] . \qquad ( 8 )$$

To keep the problem tractable, we distribute the available freedom between the two IPC controls. In doing this, however, we do not use a constant factor, but rather look at the “activity” of the two signals. If, for instance, there is large rotor yaw misalignment, this will give raise to a large rotor tilt moment, so that θ_{cm,2} will need to get larger to compensate this, while at the same time the yaw-oriented component θ_{cm,3} might be negligible. Hence, we will distribute θ^{rest} (and, of course, \dot{θ}^{rest} and \ddot{θ}^{rest}) by looking at the values of θ_{cm,2}^{unlim} and θ_{cm,3}^{unlim}, required by the IPC controller before applying any limits on them, so that the signal that is larger in absolute value gets more freedom than the “less active” signal. This idea is used in the following to derive the limits on the IPC signals θ_{cm,j}, \dot{θ}_{cm,j}, \ddot{θ}_{cm,j}, j=2, 3.

J(ψ, θ_{cm,2}, θ_{cm,3})≦θ^{rest}

Position limit:

To begin with, consider the first constraint in (8), and suppose that α₂>0 and α₃>0 are two given scalars, such that

|θ_{cm,j}|≦αⱼθ^{rest}, j={2, 3}. (9)

Then, it holds that

$$[ {max}_{ψ} J ( ψ , {θ}_{cm , 2} , {θ}_{cm , 3} ) ≡ \sqrt{( {θ}_{cm , 2}^{2} + {θ}_{cm , 3}^{2} ]} \leq {θ}^{rest} \sqrt{{α}_{2}^{2} + {α}_{3}^{2}} .$$

Since we need to make sure that J(ψ, θ_{cm,2}, θ_{cm,3})≦θ^{rest} for all ψ, the scalars α₂ and α₃ should be such that α₂²+α₃²=1. Moreover, from the discussion above, we would like that the ratio between the limits for θcm,2 and θcm,3 is proportional to the ratio between |θ_{cm,2}^{unlim}| and |θ_{cm,3}^{unlim}| (i.e., the ratio between the IPC controller outputs before applying any limits). This implies that

$$\frac{{α}_{2}}{{α}_{3}} = \frac{\vert {θ}_{cm , 2}^{unlim} \vert}{\vert {θ}_{cm , 3}^{unlim} \vert} .$$

Solving this equality together with α₂²+α₃²=1 gives:

$${α}_{j} ≐ \frac{\vert {θ}_{cm , j}^{unlim} \vert}{\sqrt{{( {θ}_{cm , 2}^{unlim} )}^{2} + {( {θ}_{cm , 3}^{unlim} )}^{2}}} , \\ j = \{ 2 , 3 \} , \qquad ( 10 )$$

which, with (9) ensures the first inequality in (8).

Speed limit: \dot{J}(ψ, θ_{cm,2}, θ_{cm,3})≦\dot{θ}^{rest}

Consider the speed constraint in (8), written as

\dot{J}(ψ, θ_{cm,2}, θ_{cm,3})=\dot{J}₂(ψ, θ_{cm,2})+\dot{J}₃(ψ, θ_{cm,3}),

\dot{J}₂(ψ, θ_{cm,2})\dot{=}Ω cos(ψ)θ_{cm,2}+sin(ψ)\dot{θ}_{cm,2},

\dot{J}₃(ψ, θ_{cm,3})\dot{=}−Ω sin(ψ)θ_{cm,3}+cos(ψ)\dot{θ}_{cm,3}.

In this case, similarly to what we did above for the position limit, we distribute θ*rest between \dot{J}(ψ, θ_{cm,3}) and \dot{J}(ψ, θ_{cm,3}) by using β₂ and β₃, such that

|\dot{J}ⱼ(ψ, θ_{cm,j})|≦βⱼ\dot{θ}^{rest}, j={2, 3}, (11)

implying

$${max}_{ψ} \dot{J} ( ψ , {θ}_{cm , 2} , {θ}_{cm , 3} ) = ( {β}_{2} + {β}_{3} ) {\dot{θ}}^{rest} ,$$

so β₂+β₃=1 must hold. This, together with

$$\frac{{β}_{2}}{{β}_{3}} = \frac{\vert {θ}_{cm , 2}^{unlim} \vert}{\vert {θ}_{cm , 3}^{unlim} \vert} , \\ gives \\ {β}_{j} ≐ \frac{\vert {θ}_{cm , j}^{unlim} \vert}{\vert {θ}_{cm , 2}^{unlim} \vert + \vert {θ}_{cm , 3}^{unlim} \vert} , \\ j = \{ 2 , 3 \} . \qquad ( 12 )$$

It remains to rewrite (11) in terms of θ_{cm,j} and \dot{θ}_{cm,j}. Here, there is another degree of freedom in the choice of distributing βⱼ\dot{θ}^{rest} over the position θ_{cm,j} and speed \dot{θ}_{cm,j}. For that purpose, we choose factors γₚₒₛ>0 and γ_{speed}>0 such that for some \dot{θ}ⱼ^{rest}>0 (derived below) we require that

|θ_{cm,j}|≦γₚₒₛ\dot{θ}ⱼ^{rest},

|\dot{θ}_{cm,j}|≦γ_{spd}\dot{θ}ⱼ^{rest}, (13)

To derive an expression for \dot{θ}ⱼ^{rest}, note that

$${max}_{ψ} {\dot{J}}_{j} ( ψ , {θ}_{cm , j} ) = \sqrt{{( Ω {θ}_{cm , j} )}^{2} + {\dot{θ}}_{cm , j}^{2}} \leq {\dot{θ}}_{j}^{rest} \sqrt{{γ}_{pos}^{2} {Ω}^{2} + {γ}_{spd}^{2}} .$$

Hence, inequality (11) will be satisfied for

$${\dot{θ}}_{j}^{rest} = \frac{{β}_{j} {\dot{θ}}^{rest}}{\sqrt{{γ}_{pos}^{2} {Ω}^{2} + {γ}_{spd}^{2}}} , \qquad ( 14 )$$

with βⱼ defined in (12).

Acceleration limit: \ddot{J}(ψ, θ_{cm,2}, θ_{cm,3})≦\ddot{θ}^{rest}

For the acceleration limit in (8), we can write

$$\ddot{J} ( ψ , {θ}_{cm , 2} , {θ}_{cm , 3} ) = {\ddot{J}}_{2} ( ψ , {θ}_{cm , 2} ) + {\ddot{J}}_{3} ( ψ , {θ}_{cm , 3} ) , \\ {\ddot{J}}_{2} ( ψ , {θ}_{cm , 2} ) \dot{=} ( {\ddot{θ}}_{cm , 2} - {Ω}^{2} {θ}_{cm , 2} ) sin ( ψ ) + ( 2 Ω {\dot{θ}}_{cm , 2} + \dot{Ω} {θ}_{cm , 2} ) cos ( ψ ) , \\ {\ddot{J}}_{3} ( ψ , {θ}_{cm , 3} ) \dot{=} ( {\ddot{θ}}_{cm , 3} - {Ω}^{2} {θ}_{cm , 3} ) cos ( ψ ) - ( 2 Ω {\dot{θ}}_{cm , 3} + \dot{Ω} {θ}_{cm , 3} ) sin ( ψ ) .$$

Similarly to the speed limit case, we distribute \ddot{θ}^{rest} between \ddot{J}(ψ, θ_{cm,2}) and \ddot{J}(ψ, θ_{cm,3}) by using the same scalars β₂ and β₃ as in (12)

|\ddot{J}ⱼ(ψ, θ_{cm,j})|≦βⱼ\ddot{θ}^{rest}, j={2, 3}, (15)

Since then we get max_{ψ}\ddot{J}(ψ, θ_{cm,2}, θ_{cm,3})=\ddot{θ}^{rest} as required in (8). Now we have even more freedom than in the speed limit case above, since we have to distribute βⱼ\dot{θ}^{rest} between three components:

the position θ_{cm,j}, the speed \dot{θ}_{cm,j} and the acceleration \ddot{θ}_{cm,j}. To do this, we choose, in addition to the already chosen factors γₚₒₛ and γ_{spd}, a third factor γ_{acc}>0, and we impose the following constraints for some \ddot{θ}^{rest}>0 that is yet to be derived

|θ_{cm,j}|≦γₚₒₛ\ddot{θ}ⱼ^{rest},

|\dot{θ}_{cm,j}|≦γ_{spd}\ddot{θ}ⱼ^{rest},

|\ddot{θ}_{cm,j}|≦γ_{acc}\ddot{θ}ⱼ^{rest}. (16)

Under these constraints we have

$${max}_{ψ} {\ddot{J}}_{j} ( ψ , {θ}_{cm , j} ) = \sqrt{{( {\ddot{θ}}_{cm , j} - {Ω}^{2} {θ}_{cm , j} )}^{2} + {( 2 Ω {\dot{θ}}_{cm , j} + \dot{Ω} {θ}_{cm , j} )}^{2}} \leq {\ddot{θ}}_{j}^{rest} \sqrt{{( {γ}_{acc} + {Ω}^{2} {γ}_{pos} )}^{2} + {( 2 Ω {γ}_{spd} + \dot{Ω} {γ}_{pos} )}^{2}}$$

Inequality (15) will then be satisfied under constraints (16) with

$${\ddot{θ}}_{j}^{rest} = \frac{{β}_{j} {\ddot{θ}}^{rest}}{\sqrt{{( {γ}_{acc} - {Ω}^{2} {γ}_{pos} )}^{2} + {( 2 {Ωγ}_{spd} + \dot{Ω} {γ}_{pos} )}^{2}}} \qquad ( 17 )$$

and βⱼ defined in (12).

To summarize, the final limits on the IPC actions in multi-blades coordinates are obtained by combining (9), (13), (16) together with the scalings (10), (12), (14), (17). In order to describe how the anti-windup scheme should finally be implemented into the wind turbine controller, we assume below that the IPC controller is discretized with sampling period of ts seconds, and will approximate the speeds and accelerations with finite differences. At time instant k, the following constraints should then be active

|θ_{c m̅,j}(k)|≦min{αⱼθ^{rest}, γₚₒₛ\dot{θ}ⱼ^{rest}, γₚₒₛ\ddot{θ}ⱼ^{rest}} (18)

|θ_{cm,j}(k)″θ_{cm,j}(k−1)|≦min{tₛγ_{spd}\dot{θ}ⱼ^{rest}, tₛγ_{spd}\ddot{θ}ⱼ^{rest}} (19)

|θ_{cm,j}(k)−2θ_{cm,j}(k−1)+θ_{cm,j}(k−2)|≦tₛ²γ_{acc}\ddot{θ}ⱼ^{rest} (20)

Notice, that both IPC controllers (4) and (5), discretized with sampling period tₛ, have the same general representation

$${C}_{IPC} ( z ) = [ \begin{matrix}\frac{{t}_{s}}{1 - {z}^{- 1}} & \\ & \frac{{t}_{s}}{1 - {z}^{- 1}}\end{matrix} ] {C}_{IPC}^{∞} ( z ) ,$$

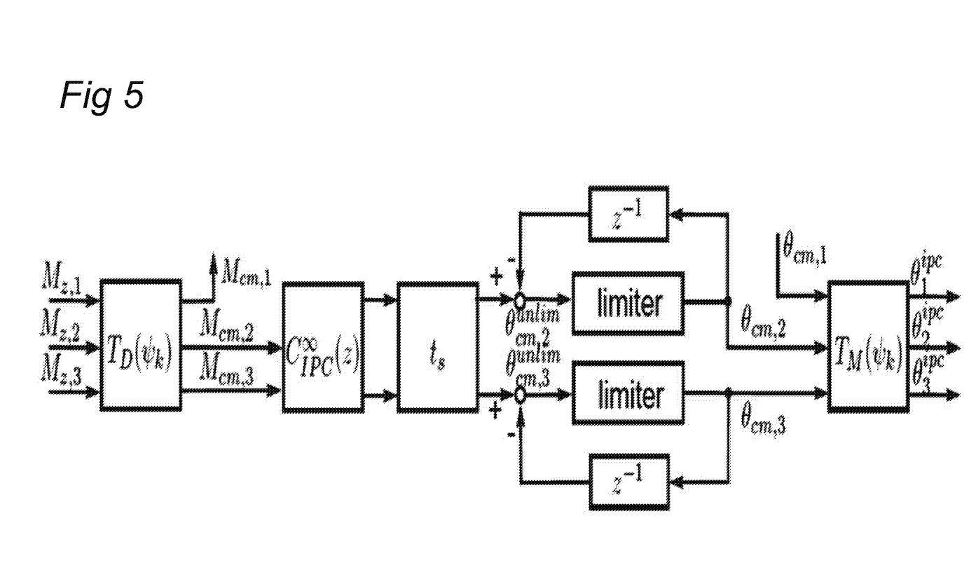

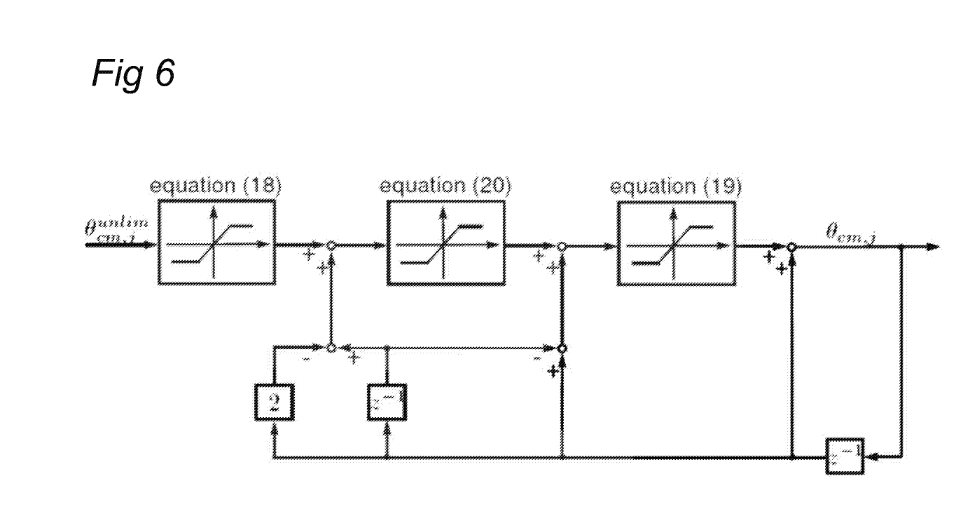

consisting of integrators at the output, followed by a transfer function (filter). As discussed in [6], in order to achieve an anti-windup mechanism one needs to make sure that the integrator states are driven by the actual (constrained) inputs θ_{cm,2} and θ_{cm,3}. This can be achieved easily by implementing the integrators by using one sample delay feedback around the limiters, as shown in FIG. 5 (of an IPC anti-windup scheme). The two limiters, having the same structure, but realizing the bounds in (18)-(20) for j={2, 3}, are shown in FIG. 6 which shows an IPC pitch limiter realization.

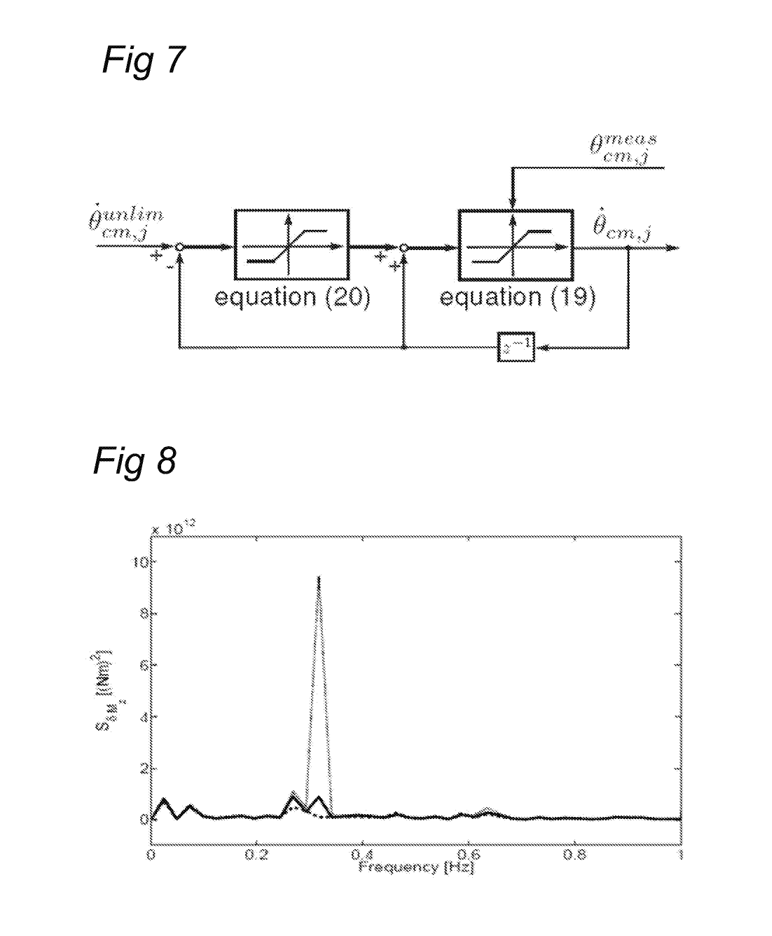

Above, the discussion was focused on the blade pitch angles 74 ᵢ being the control signals. In practice, however, it is sometimes the case that the pitch speeds \ddot{θ}ᵢ are the control variables, which leads to controller structures that contain no integrators. Indeed, an 1-compensator for IPC will take the form of a P-compensator when the pitch speed is used. For P and PD controllers, windup is not an issue, so the anti-windup scheme, presented above, will not be an issue. In this case, the limiter block can be positioned simply after the controller. However, the limiter will have a different structure than the one in FIG. 6. The reason for this is that the controller does not output a position signal. In order to incorporate position constraints, actual blade angle measurements θᵢ^{meas}(k) are necessary, which we again transform to multi-blade coordinates θ_{cm,j}^{meas} using the Coleman demodulation matrix T_{D}(ψ) (2). The corresponding limiter scheme is depicted on FIG. 7. FIG. 7 shows a limiter realization under speed control.

In this section, the methods, discussed above are demonstrated via realistic nonlinear wind turbine simulations. The simulation model is briefly described in the next subsection, after which the results of different simulations are presented, aiming to illustrate the influence of IPC on the blade loads, the operation of the rotor balancing IPC algorithm in case of blade pitch unbalance, as well as the effect of the proposed IPC anti-windup scheme.

The nonlinear wind turbine simulation model, used for generating the results in this paper, consists of the following components:
156-th order linearized structural dynamics model (SDM), obtained using the software Turbu [11]. A multi-body approach has been used to obtain this detailed SDM. The multi-body model has 14 elements per blade and 15 elements for the tower, with each element having 5 degrees of freedom. There are 6 degrees of freedom in the rotor shaft, and 12 for the pitch-servo actuation system. A linearization is computed for an aerodynamic equilibrium state at a mean wind speed of 15 m/s, rotor speed of approx. 17.7 rpm and blade pitch angle of 7.24 deg.
nonlinear aerodynamic conversion module (ADM), based on blade element momentum (BEM) theory, including dynamic wake effects, the effects of oblique inflow on the axial induction speed, and angle of attack correction due to rotor coning.

The ADM computes forces and torques per blade elements, which are used to load the SDM. See [8] for details on the ADM.
basic CPC controller, regulating the filtered generator speed at its rated level (when operating at above-rated conditions). It consisting of a PI-controller in series with low-pass filter at the 3 p blade frequency, notch filter at the first tower sidewards frequency, and notch filter at the first collective lead-lag frequency. An anti-windup scheme is implemented for this CPC controller to guarantee that constraints (7) are satisfied.
nonlinear generator torque controller based on static optimal-λ QN-curve at below rated conditions and constant power production above-rated, operating on the filtered generator speed signal (same three filters used as in pitch controller).
realistic blade effective wind speed signals are generated based on the helix approximation concept, as proposed in [8, and below], including both deterministic terms for wind shear, tower shadow, tilt and yaw misalignment, wind gust, and a stochastic term for blade-effective turbulence. The mean wind speed, used in the simulations, is 20 m/s, reaching the rotor at oblique inflow angle of 10 degrees.

To evaluate the performance of the proposed advanced IPC scheme for 1 p blade load reduction, three simulations have been performed:
Case 1: without IPC control.
Case 2: with IPC for blade load reduction, no pitch limits,
Case 3: with IPC for blade load reduction, pitch limits included.

The resulting blade 1 flapwise root bending moment spectrum for the three cases are plotted in FIG. 8. FIG. 8 shows blade 1 flapwise moment spectrum for Case 1 (dotted), Case 2 (dashed), Case 3 (solid).

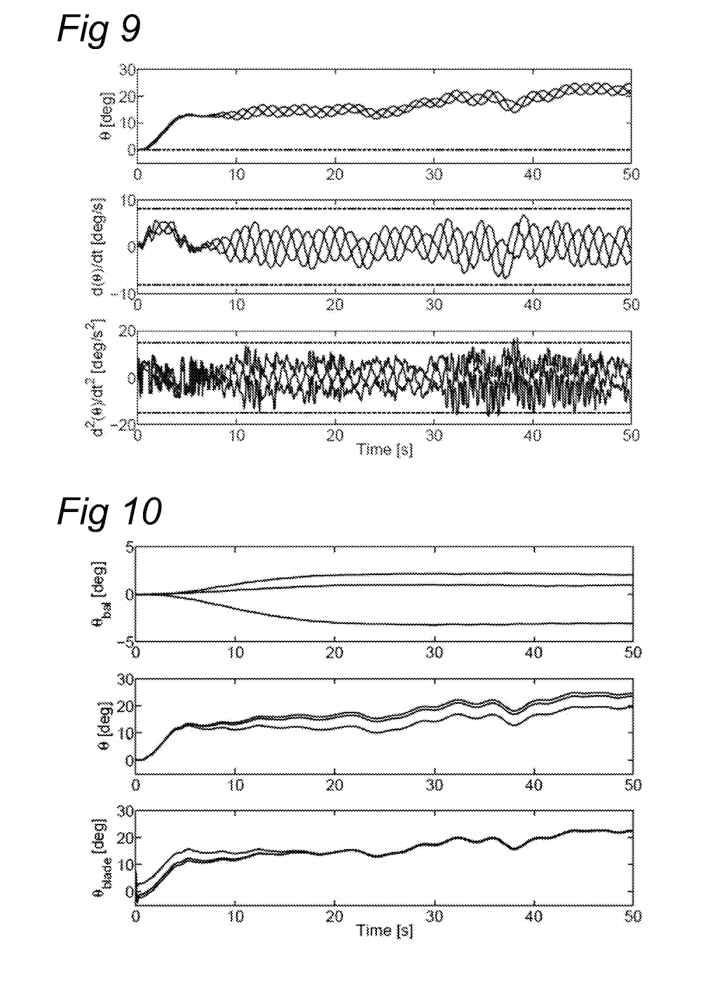

Clearly, a significant reduction of blade loads is achieved around the 1 p frequency, both without and with pitch limits (anti-windup), although the later case gives slightly less reduction, as expected. FIG. 9 shows the pitch angle, speed and acceleration under Case 3, together with their limits, given in Table 1.

For demonstrating the rotor balancing algorithm, two simulations are used:
Case 4: no rotor balancing, no IPC, no pitch limits
Case 5: rotor balancing, no IPC, no pitch limits

In both Cases 4 and 5, aerodynamic unbalance is introduced by adding offsets to the three blade pitch angles of respectively −1, 3 and −2 degrees. FIG. 10 shows pitch angles from rotor-balancing IPC (top), total pitch angle reference sent to pitch actuators (middle), actual pitch setting angles (bottom).

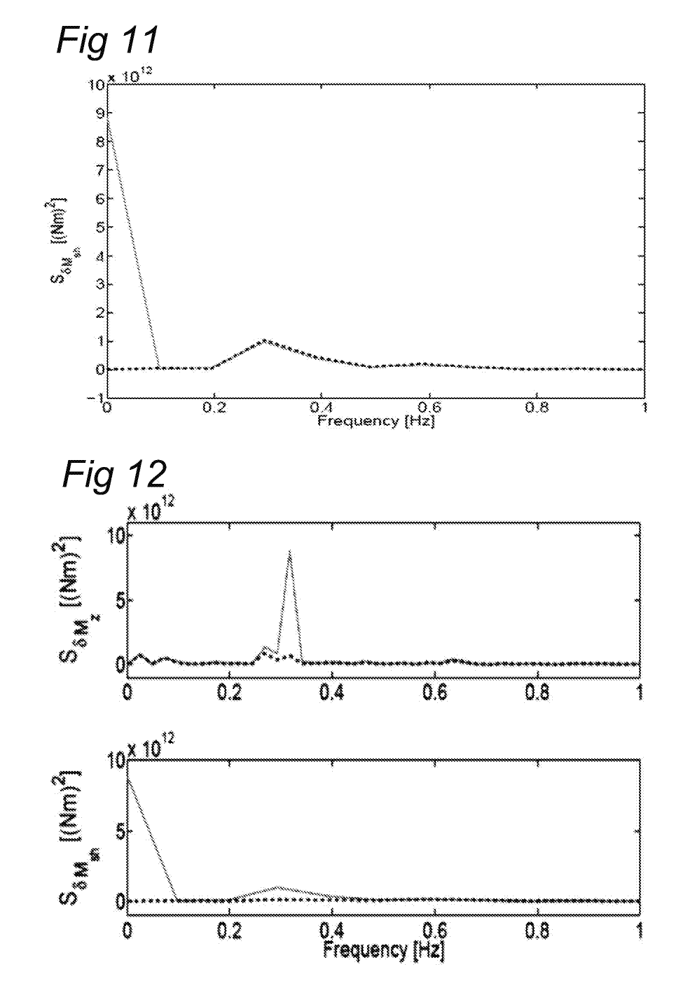

From the top plot in FIG. 10 it can be seen that the IPC rotor balancing algorithm cancel the rotor unbalance by pitching the blades to values opposite to the modeled offsets, which is done by nearly zeroing the slowly varying mean shaft moment (see FIG. 11). FIG. 11 shows a rotor shaft moment spectrum for Case 4 (solid) and Case 5 (dashed).

Finally, a simulation is performed under aerodynamic rotor unbalance (as in Cases 4 and 5) and with both IPC controllers activated, i.e.
Case 6: rotor balancing and IPC for blade load reduction, pitch limits included.

This simulation case is compared to Case 4 (aerodynamic unbalance, no IPC), and the results are presented in FIG. 12. FIG. 12 shows blade root flapwise moment (top) and shaft moment (bottom) under Case 4 (solid) and Case 6 (dashed).

Clearly, the oblique wind inflow results in a large 1 p blade root moment, which is excellently mitigated by the IPC for blade load reduction (top plot), while the large static shaft moment created by the aerodynamic unbalance is reduced by the rotor balancing scheme by pitching the blades to angles opposite to the simulated offsets (bottom plot). Although not plotted due to space limitation, the anti-windup implementation ensures that the blade pitch angles, speeds and accelerations remain within the specified limits.

TABLE 1
Numerical values of the algorithm parameters

| | parameter | | | | | | | | | | | | | | |
|---|---|---|---|---|---|---|---|---|---|---|---|---|---|---|---|
| | θₘᵢₙ | θₘₐₓ | \dot{θ}ₘᵢₙ | \dot{θ}ₘₐₓ | \ddot{θ}ₘᵢₙ | \ddot{θ}ₘₐₓ | θₘᵢₙ^{col} | θₘₐₓ^{col} | \dot{θ}ₘᵢₙ^{col} | \dot{θ}ₘₐₓ^{col} | \ddot{θ}ₘᵢₙ^{col} | \ddot{θ}ₘₐₓ^{col} | γₚₒₛ | γ_{spd} | γ_{acc} |
| value | 0 | 85 | −8 | 8 | −15 | 15 | 0 | 85 | −4 | 4 | −5 | 5 | 4 | 1 | 8 |
| dimension | ° | ° | °/s | °/s | °/s² | °/s² | ° | ° | °/s | °/s | °/s² | °/s² | — | — | — |

Above, the embodiment described relates to an individual pitch control (IPC) algorithm which is arranged for 1 p blade load reduction in a wind turbine also referred to as single mode IPC. The wind turbine comprises a rotor and a mast, wherein the rotor comprises a rotor shaft that is provided with an n number of blades, wherein the rotor shaft is connected to a top section of the mast.

Further, the wind turbine is equipped with a sensor circuit arranged for determining and monitoring loads on the blades of the wind. Additionally, a blade pitch sensor is arranged for monitoring a set blade pitch for each of the rotor blades.

Basically, the present invention relates to a method for blade load reduction control of a rotor of a wind turbine, in which the rotor is equipped with a plurality of blades, a pitch angle of each blade being controllable by an associated actuator;

in which the method comprises:

measuring a rotor azimuth angle signal;

measuring mechanical load parameters on the rotor;

providing a collective pitch control CPC for a collective pitch angle setting of the blades based on a rotor speed, derived from the rotor azimuth angle signal;

providing an individual pitch control IPC, in order, comprising:
a—transforming the measured mechanical load parameters from a rotational reference frame to a mechanical load on the rotor in a fixed reference frame;
b—in the fixed reference frame, determining, based on the mechanical load on the rotor, for reduction of the mechanical load, two multi-blade pitch angles;
c—in the fixed reference frame, correcting the two multi-blade pitch angles to corrected multi-blade pitch angles by using a constraint condition, the constraint condition defining actuator limitations for the actuator associated with each respective blade;
d—inversely transforming the corrected multi-blade pitch angles in the fixed reference frame to an individual pitch deviation angle for each blade in the rotational reference frame, each individual pitch deviation angle being relative to the collective pitch angle;
e—in the rotational reference frame, adding up for each blade, the respective individual pitch deviation angle to the collective pitch angle to form an individual pitch angle for each blade;

and

controlling the associated actuator for each blade to set a pitch of the respective blade to the individual pitch angle for the respective blade.

Accordingly, according to an aspect, the IPC algorithm is arranged to receive as input a blade moment at each blade of the wind turbine from the respective sensor coupled to the respective blade.

Next, the IPC algorithm is arranged to transform the individual blade moment for each blade into an overall load exerted on the total rotor in a fixed rotor reference frame, in which the overall load comprises an axial load (along the direction of the axis) and static yaw and tilt moments on the rotor axis.

The transformation is arranged so as to map 1 p loads into the static yaw and tilt moments.

Then, the IPC algorithm is arranged to reduce the static yaw and tilt moments of the overall load by adjusting two multi blade pitch angles for the total rotor in the fixed reference frame.

Finally, the IPC algorithm is arranged to inversely transform the adjusted two multi blade pitch angles back into individual blade angles for each individual blade of the rotor in the rotational reference frame.

By the inverse transformation, the calculated reduction of the static yaw and tilt moments of the overall load is translated into a reduction of the 1 p blade loads.

In a further embodiment, the present invention relates to a multi-mode IPC controller and method which is arranged for np blade load reduction in a wind turbine which is here referred to as multi-mode IPC.

In this embodiment, the method as defined above further comprises: measuring mechanical load parameters on the rotor;

providing at least one further individual pitch control IPC, comprising:
f—providing a further transformation of the measured mechanical load parameters from a rotational reference frame to a further mechanical load on the rotor in a transformed reference frame;
g—in the transformed reference frame, determining, based on the further mechanical load, for reduction of the further mechanical load, two further multi-blade pitch angles;
h—in the transformed reference frame, correcting each further multi-blade pitch angle to a further corrected multi-blade pitch angle by using a constraint condition, the constraint condition defining actuator limitations for the actuator associated with each respective blade;
i—inversely transforming the further corrected multi-blade pitch deviation angle in the transformed reference frame to a further individual pitch deviation angle in the rotational reference frame, each further individual pitch deviation angle being relative to the collective pitch angle;
j—adding up for each blade, the respective further individual pitch deviation angle to the collective pitch angle to form an individual pitch angle for each blade in the rotational reference frame.

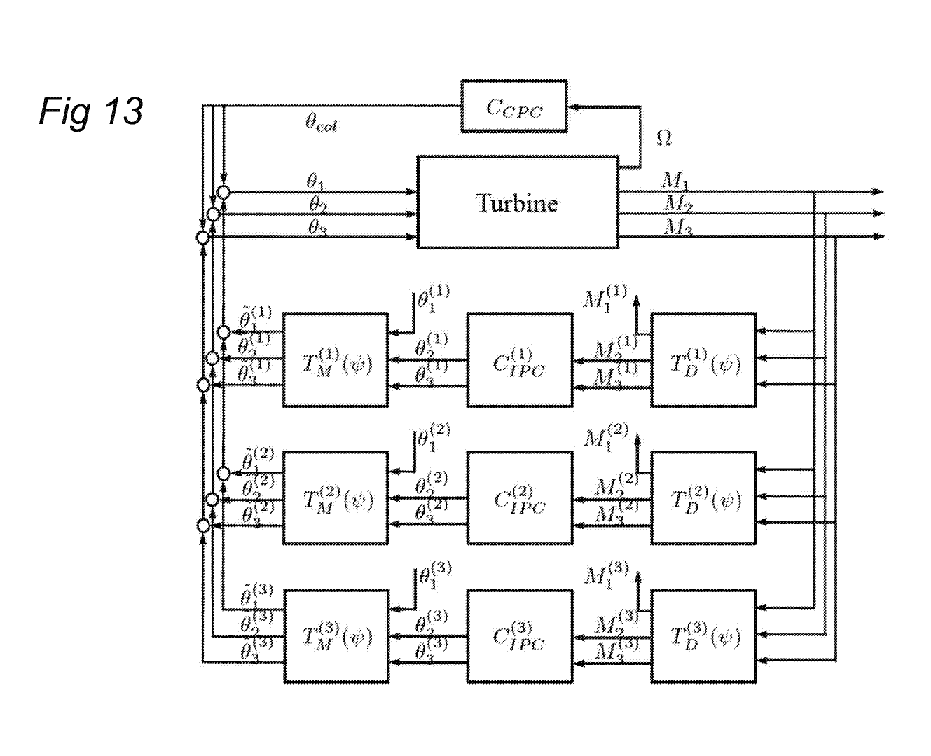

FIG. 13 shows a schematic overall structure of a multimode IPC controller arrangement.

In this embodiment, the multi-mode IPC controller relates to a controller arrangement having three modes. The skilled person may appreciate that a multi mode IPC controller is arranged for at least two modes of operation.

In the overall structure of FIG. 13 a wind turbine WT is operatively coupled to a CPC controller (CPC: collective pitch control). The CPC controller is arranged to receive a value SI of the rotor speed from the wind turbine. Further, the CPC controller is arranged to generate a collective blade setting θ_{col} for the blades of the rotor of the wind turbine.

Further, wind turbine WT is operatively coupled to a plurality of IPC controllers C_{IPC}⁽¹⁾, C_{IPC}⁽²⁾, C_{IPC}⁽³⁾ through a respective Coleman demodulation unit T_{D}⁽¹⁾(ψ), T_{D}⁽²⁾(ψ), T_{D}⁽³⁾(ψ).

The Coleman demodulation is given by:

$${T}_{D}^{( n )} ( ψ ) = [ \begin{matrix}\frac{1}{3} & \frac{1}{3} & \frac{1}{3} \\ \frac{2}{3} sin ( n ψ ) & \frac{2}{3} sin ( n ( ψ + \frac{2 π}{3} ) ) & \frac{2}{3} sin ( n ( ψ + \frac{4 π}{3} ) ) \\ \frac{2}{3} cos ( n ψ ) & \frac{2}{3} cos ( n ( ψ + \frac{2 π}{3} ) ) & \frac{2}{3} cos ( n ( ψ + \frac{4 π}{3} ) )\end{matrix} ] ,$$

And the inverse operation is given by:

$${T}_{M}^{( n )} ( ψ ) = [ \begin{matrix}1 & sin ( n ψ ) & cos ( n ψ ) \\ 1 & sin ( n ( ψ + \frac{2 π}{3} ) ) & cos ( n ( ψ + \frac{2 π}{3} ) ) \\ 1 & sin ( n ( ψ + \frac{4 π}{3} ) ) & cos ( n ( ψ + \frac{4 π}{3} ) )\end{matrix} ] .$$

Each Coleman demodulation unit is arranged to receive as input a blade moment at each blade of the wind turbine from the respective sensor coupled to the respective blade and to apply a transformation to static yaw and tilt moments as described above from a blade load at a predetermined multiple-of-p frequency (denoted xp).

The Coleman demodulation unit T_{D}⁽¹⁾(ψ) is for example arranged for transformation from 1 p blade loads. The Coleman demodulation unit T_{D}⁽²⁾(ψ) is for example arranged for transformation from 2 p blade loads. The Coleman demodulation unit T_{D}⁽³⁾(ψ) is for example arranged for transformation from 3 p blade loads.

Each IPC controller C_{IPC}⁽¹⁾, C_{IPC}⁽²⁾, C_{IPC}⁽³⁾ is arranged to receive as derived by the associated Coleman demodulation unit for the respective xp blade load (1 p, 2 p, 3 p) and to reduce those static yaw and tilt moments of the overall load for the respective xp blade load by adjusting yaw and pitch angles for the total rotor.

Each IPC controller C_{IPC}⁽¹⁾, C_{IPC}⁽²⁾, C_{IPC}⁽³⁾ operatively coupled to a retransformation unit T_{M}⁽¹⁾(ψ), T_{M}⁽²⁾(ψ), T_{M}⁽³⁾(ψ) and is arranged to transmit the adjusted yaw and pitch values to the respective retransformation unit.

Each retransformation unit is arranged to inversely transform (with relation to the Coleman demodulation) the adjusted yaw and pitch angles back into individual blade angles for each individual blade of the rotor in relation to the respective xp blade load (1 p, 2 p, 3 p).

Finally, the values of the blade angles for the various xp blade loads are recombined and summed with the collective blade setting θ_{col} to obtain individual blade angle settings for each blade of the rotor, wherein each blade angle setting is adapted for each of the frequency dependencies of the blade loads (in this example, 1 p, 2 p, 3 p).

Advantageously, the multi-mode IPC controller arrangement allows to reduce blade load variations of various frequency to be reduced simultaneously.

Below, the multi mode IPC controller arrangement is described in more detail.

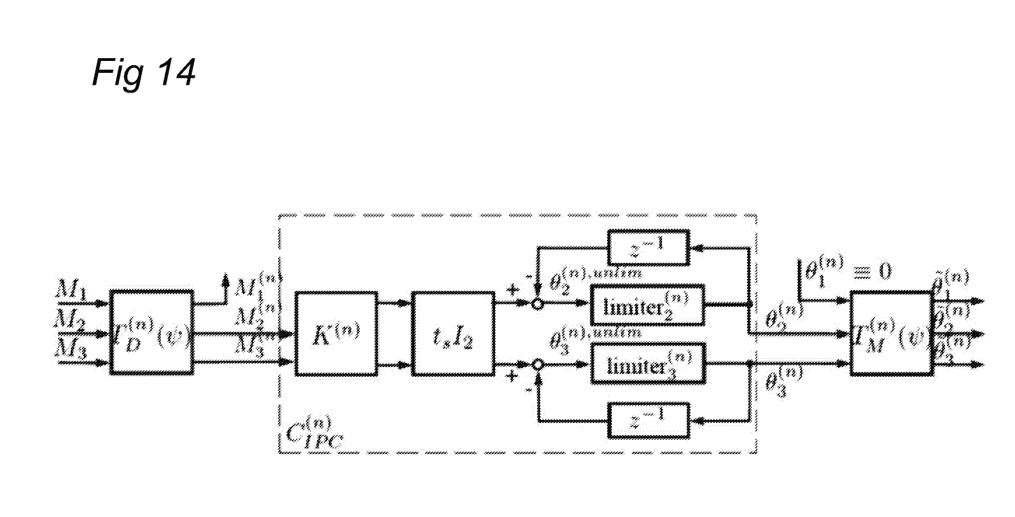

Since the integral controllers C_{IPC}⁽ⁿ⁾(s) act on np-modulated signals, we need to limit the controller outputs θᵢ⁽ⁿ⁾ for for each blade of the rotor in such a way that the original actuator constraints are satisfied. To this end, the constraints on the blade pitch signals are transformed below to constraints on the modulated pitch signals for subsequent implementation in the anti-windup scheme of an integral controller in FIG. 14. This transformation of the constraints follows the same ideas as described above in more detail where this was done for 1 p blade load control only. Here, this constraints transformation is generalized to multi-mode IPC control, and is based on the following reasoning:
A part of the overall available actuation freedom is attributed to the collective pitch control (CPC) action, θ_{col}:

θₘᵢₙ≦θₘᵢₙ^{col}≦θ_{col}≦θₘₐₓ^{col}≦θₘₐₓ

\dot{θ}ₘᵢₙ<\dot{θ}ₘᵢₙ^{col}≦\dot{θ}_{col}≦\dot{θ}ₘₐₓ^{col}<\dot{θ}ₘₐₓ

\ddot{θ}ₘᵢₙ<\ddot{θ}ₘᵢₙ^{col}≦\ddot{θ}_{col}≦\ddot{θ}ₘₐₓ^{col}<\ddot{θ}ₘₐₓ (21)
The remaining actuation freedom (i.e. the part from the total actuation freedom which is not being used up by the CPC controller) is given to the IPC controllers:

θ^{rest}(k)\dot{=}max{0, min{θₘₐₓ−θ_{col}(k), θ_{col}(k)−θₘᵢₙ}},

\dot{θ}^{rest}(k)\dot{=}max{0, min{\dot{θ}ₘₐₓ−\dot{θ}_{col}(k), \dot{θ}_{col}(k)−\dot{θ}ₘᵢₙ}}.

\ddot{θ}^{rest}(k)\dot{=}max{0, min{\ddot{θ}ₘₐₓ−\ddot{θ}_{col}(k), \ddot{θ}_{col}(k)−\ddot{θ}ₘᵢₙ}}, (22)
The remaining actuation freedom is subdivided between the different IPC control loops for 1 p,2 p, . . . , N p, blade load reduction. This is done by attributing weighting factors to the IPC controllers, which factors can be different for the position, speed and acceleration constraints, and could be selected using the standard deviation (std) of the unlimited positions, speeds and accelerations of the controller outputs in rotating coordinates. More specifically, by simulating the wind turbine without actuator limitations, the following parameters are computed for j=1, 2, . . . , N to be used later on

$${θ}_{i} = {θ}_{col} + {\sum }_{j = 1}^{N} sin [ j ( ψ + \frac{2 π ( i - 1 )}{3} ) ] {θ}_{i}^{( j )} + cos [ j ( ψ + \frac{2 π ( i - 1 )}{3} ) ] {θ}_{3}^{( j )} . \qquad ( 23 )$$

For each IPC controller, the position, speed and acceleration constraints are further divided between the tilt and yaw oriented components, i.e. between θ₂^{(n) and θ}₃⁽ⁿ⁾, depending on the size of these signals before the limitation is applied (θ₂^{(n)unlim} and θ₃^{(n)unlim} on FIG. 14).

Below, these steps are described in more detail.

From FIG. 13 and the equations on the Coleman demodulation T_{D}⁽ⁿ⁾(ψ) and inverse transformation T_{M}⁽ⁿ⁾(ψ) it follows that the pitch angle demand for blade i at time instant k are given by

$${θ}_{i} = {θ}_{col} + {\sum }_{j = 1}^{N} {\underbrace{sin [ j ( ψ + \frac{2 π ( i - 1 )}{3} ) ] {θ}_{i}^{( j )} + cos [ j ( ψ + \frac{2 π ( i - 1 )}{3} ) ] {θ}_{3}^{( j )}}}_{{\tilde{θ}}_{i}^{( j )}} .$$

where N is the total number of IPC controllers. By defining

$${θ}_{i}^{ipc} = {\sum }_{i = 1}^{N} {\tilde{θ}}_{i}^{( j )} ,$$

the goal is to construct position, speed and acceleration limits on the signals θ₂^{(j)} and θ₃^{(j)} with (j=1, 2, . . . , N) that imply for every i=1, 2, 3

|θᵢ^{ipc}|≦θ^{rest}(k),

|\dot{θ}ᵢ^{ipc}|≦\dot{θ}^{rest}(k).

|\ddot{θ}ᵢ^{ipc}|≦\ddot{θ}^{rest}(k). (24)

Before we do that, the following fact is reported, which will be used on several occasions in the sequel:

$${max}_{ψ ∈ ℝ} ( sin ( ψ ) a + cos ( ψ ) b ) = \sqrt{{a}^{2} + {b}^{2}} , ∀ a , b ∈ ℝ . \qquad ( 25 )$$

mmIPC Position Constraints

In this subsection we will derive scalars αᵢ^{(j)}≧0, i=2, 3, j=1, 2, . . . , N, for which the inequalities

|θᵢ^{(j)}|≦αᵢ^{(j)}θ^{rest}(k), (26)

will imply the position constraints in equation (8). To this end, notice that from equation (25) it follows that

$${max}_{ψ} {\tilde{θ}}_{i}^{( j )} = \sqrt{{( {θ}_{2}^{( j )} )}^{2} + {( {θ}_{3}^{( j )} )}^{2}} ,$$

so that

$${max}_{ψ} {θ}_{i}^{ipc} \leq {\sum }_{j = 1}^{N} \sqrt{{( {θ}_{2}^{( j )} )}^{2} + {( {θ}_{3}^{( j )} )}^{2}} .$$

Hence, from (26) it follows that

$${max}_{ψ} {θ}_{i}^{ipc} \leq {θ}^{rcst} ( k ) {\sum }_{j = 1}^{N} \sqrt{{( {α}_{2}^{( j )} )}^{2} + {( {α}_{3}^{( j )} )}^{2}} .$$

Then from (26) follows that the αᵢ^{(j)} should be such that

$${\sum }_{j = 1}^{N} \sqrt{{( {α}_{2}^{( j )} )}^{2} + {( {α}_{3}^{( j )} )}^{2}} = 1. \qquad ( 27 )$$

Furthermore, in order to distribute the available actuation freedom fairly between the controllers, the standard deviations (23) will be used as weighting functions so that a controller that required more pitch activity in the unconstrained case will receive a higher weight in the distribution of the constraints. To achieve that, we impose the following condition on the αᵢ^{(j)}'s (which imply (27))

$$\sqrt{{( {α}_{2}^{( j )} )}^{2} + {( {α}_{3}^{( j )} )}^{2}} = \frac{{σ}_{pos}^{( j )} \sqrt{{( {θ}_{2}^{( j ) , unlim} )}^{2} + {( {θ}_{3}^{( j ) , unlim} )}^{2}}}{{\sum }_{l = 1}^{N} {σ}_{pos}^{( l )} \sqrt{{( {θ}_{2}^{( l ) , unlim} )}^{2} + {( {θ}_{3}^{( l ) , unlim} )}^{2}}} ; \qquad ( 28 )$$

where θᵢ^{(j)unlim} denotes the control action θᵢ^{(j)} just before the limitation (see FIG. (14)).

Finally, the available actuation freedom needs to be redistributed also among the two components (outputs) θ₂^{(j)} and θ₃^{(j)} of each IPC controller. This is done by requiring that αᵢ^{(j)}'s are such that

$$\frac{{α}_{2}^{( j )}}{{α}_{3}^{( j )}} = \frac{\vert {θ}_{2}^{( j ) , unlim} \vert}{\vert {θ}_{3}^{( j ) , unlim} \vert} . \qquad ( 29 )$$

It can be shown that the following expression represents the unique solution to (27), (28) and (29):

$${α}_{i}^{( j )} = \frac{{σ}_{pos}^{( j )} \vert {θ}_{i}^{( j ) , unlim} \vert}{{\sum }_{l = 1}^{N} {σ}_{pos}^{( l )} \sqrt{{( {θ}_{2}^{( l ) , unlim} )}^{2} + {( {θ}_{3}^{( l ) , unlim} )}^{2}}} . \qquad ( 30 )$$

mmIPC Speed Constraints

Below we will derive scalars βᵢ^{(j)}≧0, i=2, 3, j=1, 2, . . . , N, such that the inequalities

|θᵢ^{(j)}|≦γₚₒₛβᵢ^{(j)}\dot{θ}^{rest}(k),

|\dot{θ}ᵢ^{(j)}|≦γ_{spd}βᵢ^{(j)}\dot{θ}^{rest}(k), (31)

imply the speed constraints in equation (24). The parameters γₚₒₛ and γ_{spd} (as well as γ_{acc} defined in the next section) are user defined positive scalar weights used to distribute the original speed, constraints to position and speed constraints on the output of the IPC controllers. This is necessary because both θᵢ^{(j)} and \dot{θ}ᵢ^{(j)} influence the final blade pitch speeds

$$\frac{\partial }{\partial t} {\tilde{θ}}_{i}^{( j )}$$

after the modulation.

Notice also, that the parameters γₚₒₛ and γ_{spd} act as weightings and are only required to be positive; they need not to be smaller than one, or sum up to one. To begin with, first we express the derivative of θᵢ^{ipc}

$$\frac{d }{d t} {θ}_{i}^{ipc} = {\sum }_{i = 1}^{N} \frac{d }{d t} {\tilde{θ}}_{i}^{( j )} , \\ with$$

$$\frac{d }{d t} {\tilde{θ}}_{i}^{( j )} = cos [ j ( ψ + \frac{2 π ( i - 1 )}{3} ) ] ( j Ω ) {θ}_{2}^{( j )} + sin [ j ( ψ + \frac{2 π ( i - 1 )}{3} ) ] {\dot{θ}}_{2}^{( j )} - sin [ j ( ψ + \frac{2 π ( i - 1 )}{3} ) ] ( j Ω ) {θ}_{3}^{( j )} + cos [ j ( ψ + \frac{2 π ( i - 1 )}{3} ) ] {\dot{θ}}_{3}^{( j )}$$

Hence, using equation (25) the following holds

$${max}_{ψ} \frac{d }{d t} {\tilde{θ}}_{i}^{( j )} \leq \sqrt{{( j Ω {θ}_{2}^{( j )} )}^{2} + {( {\dot{θ}}_{2}^{( j )} )}^{2}} + \sqrt{{( j Ω {θ}_{3}^{( j )} )}^{2} + {( {\dot{θ}}_{3}^{( j )} )}^{2}} \leq {\dot{θ}}^{rest} ( k ) ( {β}_{2}^{( j )} + {β}_{3}^{( j )} ) \sqrt{{( j {Ωγ}_{pos} )}^{2} + {γ}_{spd}^{2}} .$$

In order that the above inequalities for j=1, 2, . . . , N imply the speed constraint in (24), the βᵢ^{(j)}'s should be such that

$${\sum }_{j = 1}^{N} ( {β}_{2}^{( j )} + {β}_{3}^{( j )} ) \sqrt{{( j {Ωγ}_{pos} )}^{2} + {γ}_{spd}^{2}} = 1.$$

Furthermore, similarly to what we did in the previous section, we distribute the constraints among the separate controllers by imposing the condition (which implies the equation above)

$${β}_{2}^{( j )} + {β}_{3}^{( j )} = \frac{1}{\sqrt{{( j {Ωγ}_{pos} )}^{2} + {γ}_{spd}^{2}}} \frac{{σ}_{spd}^{( j )} ( {f}_{2}^{( j )} + {f}_{3}^{( j )} )}{{\sum }_{l = 1}^{N} {σ}_{spd}^{( l )} ( {f}_{2}^{( l )} + {f}_{3}^{( l )} )} , \qquad$$

wherein the following notation is introduced for notational simplicity

ƒᵢ^{(j)}={square root over ((jΩθᵢ^{(j),unlim})²+(\dot{θ}{square root over (\dot{θ}ᵢ^{(j),unlim})²)}. (32)

Finally, the last condition on the βᵢ^{(j)}'s comes from the desired constraints distribution between tilt (θ₂^{(j)}) and yaw (θ₃^{(j)}) output channels of the controllers:

$$\frac{{β}_{2}^{( j )}}{{β}_{3}^{( j )}} = \frac{{f}_{2}^{( j )}}{{f}_{3}^{( j )}} .$$

Altogether, these give the following unique expression for the βᵢ^{(j)}'s.

$${β}_{i}^{( j )} = \frac{1}{\sqrt{{( j {Ωγ}_{pos} )}^{2} + {γ}_{spd}^{2}}} \frac{{f}_{i}^{( j )}}{{f}_{2}^{( j )} + {f}_{3}^{( j )}} \cdot \frac{{σ}_{spd}^{( j )} ( {f}_{2}^{( j )} + {f}_{3}^{( j )} )}{{\sum }_{l = 1}^{N} {σ}_{spd}^{( l )} ( {f}_{2}^{( l )} + {f}_{3}^{( l )} )} , \qquad ( 33 )$$

With ƒᵢ^{(j)} defined in equation (32).

mmIPC Acceleration Constraints

Finally, in this section the constraints on the accelerations of IPC controllers' output signals θ₂^{(j)} and θ₃^{(j)} are derived. In this case, the positions θᵢ^{(j)}, speeds \dot{θ}ᵢ^{(j)} and accelerations \ddot{θ}ᵢ^{(j)} have all influence on the acceleration of the modulated blade pitch accelerations

$$\frac{{\partial }^{2}}{\partial {t}^{2}} {\tilde{θ}}_{i}^{( j )} ,$$

so that now we will search for positive scalars γᵢ^{(j)}, i=2, 3, j=1, 2, . . . , N, that distribute the available total acceleration limit \ddot{θ}^{rest}(k) between the IPC control loops, such that the following conditions on the IPC controllers' outputs

|θᵢ^{(j)}|≦γₚₒₛγᵢ^{(j)}\ddot{θ}^{rest}(k),

|\dot{θ}ᵢ^{(j)}|≦γ_{spd}γᵢ^{(j)}\ddot{θ}^{rest}(k),

|\ddot{θ}ᵢ^{(j)}|≦γ_{acc}γᵢ^{(j)}\ddot{θ}^{rest}(k), (34)

will imply the acceleration constraints in equation (24). The parameters γₚₒₛ and γ_{spd} were already defined in the previous section for distribution of the speed freedom \dot{θ}^{rest}(k) between the position and speed for a given IPC controller j (see equation (31)).

In addition to these, now a third parameter, γ_{acc}, for the acceleration constraint. Notice again, that the parameters γₚₒₛ, γ_{spd} and γ_{acc} are weighting parameters that are just required to be positive; they need not to be smaller than one, or sum up to one. The second derivative of the “IPC part” of the final blade pitch angle signals is given by

$$\frac{{d}^{2}}{d {t}^{2}} {θ}_{i}^{ipc} = {\sum }_{i = 1}^{N} \frac{{d}^{2}}{d {t}^{2}} {\tilde{θ}}_{i}^{( j )} , \\ With$$

$$\frac{{d}^{2}}{d {t}^{2}} {\tilde{θ}}_{i}^{( j )} = sin [ j ( ψ + \frac{2 π ( i - 1 )}{3} ) ] ( {\ddot{θ}}_{2}^{( j )} + {( j \dot{Ω} )}^{2} {θ}_{2}^{( j )} ) + cos [ j ( ψ + \frac{2 π ( i - 1 )}{3} ) ] ( 2 j Ω {\dot{θ}}_{2}^{( j )} + j \dot{Ω} {θ}_{2}^{( j )} ) cos [ j ( ψ + \frac{2 π ( i - 1 )}{3} ) ] ( {\ddot{θ}}_{3}^{( j )} + {( j Ω )}^{2} {θ}_{3}^{( j )} ) - sin [ j ( ψ + \frac{2 π ( i - 1 )}{3} ) ] ( 2 j Ω {\dot{θ}}_{3}^{( j )} + j \dot{Ω} {θ}_{3}^{( j )} ) .$$

Therefore, from equation (25) it follows that

$${max}_{ψ} \frac{{d}^{2}}{d {t}^{2}} {\tilde{θ}}_{i}^{( j )} \leq \sqrt{{( {\ddot{θ}}_{2}^{( j )} + {( j Ω )}^{2} {θ}_{2}^{( j )} )}^{2} + {( 2 j Ω {\dot{θ}}_{2}^{( j )} + j \dot{Ω} {θ}_{2}^{( j )} )}^{2}} + \sqrt{{( {\ddot{θ}}_{3}^{( j )} + {( j Ω )}^{2} {θ}_{3}^{( j )} )}^{2} + {( 2 j Ω {\dot{θ}}_{3}^{( j )} + j \dot{Ω} {θ}_{3}^{( j )} )}^{2}} \leq {\ddot{θ}}^{rest} ( k ) ( {γ}_{2}^{( j )} + {γ}_{3}^{( j )} ) \sqrt{{( {γ}_{acc} + {( jΩ )}^{2} {γ}_{pos} )}^{2} + {( 2 {jΩγ}_{spd} + j \dot{Ω} {γ}_{pos} )}^{2}} .$$

Since these inequalities for j=1, 2, . . . , N need to imply the acceleration constraint in (24), the γᵢ^{(j)}'s must satisfy

$${\sum }_{j = 1}^{N} ( {γ}_{2}^{( j )} + {γ}_{3}^{( j )} ) \sqrt{{( {γ}_{acc} + {( jΩ )}^{2} {γ}_{pos} )}^{2} + {( 2 {jΩγ}_{spd} + j \dot{Ω} {γ}_{pos} )}^{2}} = 1. \qquad ( 35 )$$

By defining the following notation

$${g}_{i}^{( j )} = \sqrt{{( {\ddot{θ}}_{i}^{( j ) , unlim} + {( jΩ )}^{2} {θ}_{i}^{( j ) , umlim} )}^{2} + {( 2 j Ω {\dot{θ}}_{i}^{( j ) , unlim} + j \dot{Ω} {θ}_{i}^{( j ) , unlim} )}^{2}} . \qquad ( 36 )$$

in order to distribute the acceleration freedom \ddot{θ}^{rest}(k) between the different control loops by taking the contribution of each controller (being (g₂^{(j)}+g₃^{(j)}) for the j-th controller) to the overall blade pitch acceleration weighed by the standard deviations σ_{acc}^{(j)} 23), we require that

$${γ}_{2}^{( j )} + {γ}_{3}^{( j )} = \frac{1}{\sqrt{{( {γ}_{acc} + {( jΩ )}^{2} {γ}_{pos} )}^{2} + {( 2 {jΩγ}_{spd} + j \dot{Ω} {γ}_{pos} )}^{2}}} \frac{{σ}_{acc}^{( j )} ( {g}_{2}^{( j )} + {g}_{3}^{( j )} )}{{\sum }_{l = 1}^{N} {σ}_{acc}^{( l )} ( {g}_{2}^{( l )} + {g}_{3}^{( l )} )} .$$

Clearly, this condition already implies (35). Finally, the γᵢ^{(j)}'s get uniquely defined by adding the following condition for the distribution of the acceleration activity of the j-th IPC controller between its two outputs θ₂^{(j)}(tilt) and θ₃^{(j)}(yaw)

$$\frac{{γ}_{2}^{( j )}}{{γ}_{3}^{( j )}} = \frac{{g}_{2}^{( j )}}{{g}_{3}^{( j )}} .$$

This gives rise to the following final expression

$${γ}_{i}^{( j )} = \frac{1}{\sqrt{{( {γ}_{acc} + {( jΩ )}^{2} {γ}_{pos} )}^{2} + {( 2 {jΩγ}_{spd} + j \dot{Ω} {γ}_{pos} )}^{2}}} \frac{{g}_{i}^{( j )}}{{g}_{2}^{( j )} + {g}_{3}^{( j )}} \frac{{σ}_{acc}^{( j )} ( {g}_{2}^{( j )} + {g}_{3}^{( j )} )}{{\sum }_{l = 1}^{N} {σ}_{acc}^{( l )} ( {g}_{2}^{( l )} + {g}_{3}^{( l )} )} \qquad ( 37 )$$

with gᵢ^{(j)} defined in equation (36).

Final Form of Limiters in mmIPC Anti-Windup Scheme

The derived constraints on position, speed and accelerations of the IPC controllers' outputs (equations (26), (31) and (34)) can be summarized as follows

|θᵢ^{(j)}|≦min{αᵢ^{(j)}θ^{rest}(k), γₚₒₛβᵢ^{(j)}\dot{θ}^{rest}(k), γₚₒₛγᵢ^{(j)}\ddot{θ}^{rest}(k)},

|\dot{θ}ᵢ^{(j)}|≦min{γ_{spd}βᵢ^{(j)}\dot{θ}^{rest}(k), γ_{spd}γᵢ^{(j)}\ddot{θ}^{rest}(k)},

|\ddot{θ}ᵢ^{(j)}|≦γ_{acc}γᵢ^{(j)}\ddot{θ}^{rest}(k).

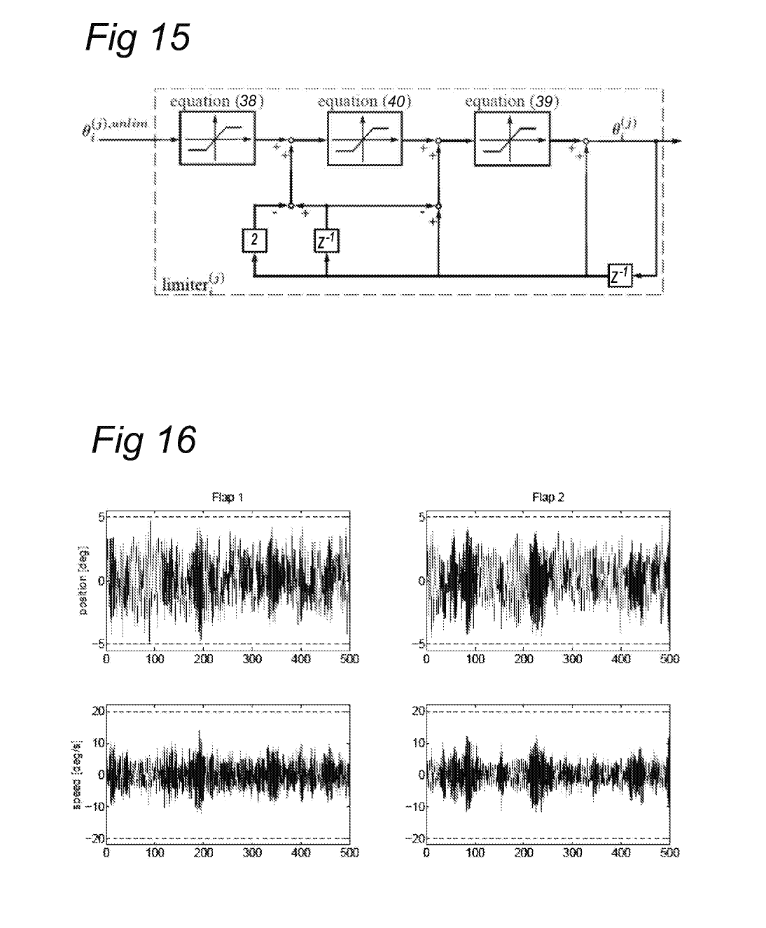

FIG. 15 shows an IPC pitch limiter realization. By using finite difference approximations of the speeds and accelerations, the limiters in the anti-windup scheme in FIG. 14 can be implemented as shown in FIG. 15 with

|θᵢ^{(j)}(k)|≦min{αᵢ^{(j)}θ^{rest}(k), γₚₒₛβᵢ^{(j)}\dot{θ}^{rest}(k), γₚₒₛγᵢ^{(j)}\ddot{θ}^{rest}(k)} (38)

|θᵢ^{(j)}(k)−θᵢ^{(j)}(k−1)|≦tₛ min{γ_{spd}βᵢ^{(j)}\dot{θ}^{rest}(k), γ_{spd}γᵢ^{(j)}\ddot{θ}^{rest}(k)} (39)

|θᵢ^{(j)}(k)−2θᵢ^{(j)}(k−1)+θᵢ^{(j)}(k−1)|≦tₛ²γ_{acc}γᵢ^{(j)}\ddot{θ}^{rest}(k) (40)

The control loops, considered above, concern 1 p, 2 p, and higher load reduction (see, e.g., FIG. 13. These separate loops have one thing in common: they are all defined on modulated input (θᵢ^{(j)}) and output (Mᵢ^{(j)}) signals. In addition to these loops, it is also possible to include another loop for reduction of quasi-static loads, i.e. 0 p control. To this end, the deviation of the mean value of the blade root moments from its equilibrium value, M₁⁽¹⁾−M_{1,eq}⁽¹⁾ can be fed back to the “collective” pitch signal θ₁⁽¹⁾, as shown in FIG. 15. This loop, called here 0 p control as it can be used to reduce quasi-static loads, requires no modulation of signals, as can be observed by inspecting the first row and the first column of the matrices no and T_{D}⁽¹⁾ and T_{M}⁽¹⁾, respectively.

It can be shown that the inclusion of such an 0 p IPC control loop leads to the following modifications of the factors αᵢ^{(j)}, βᵢ^{(j)}, and γᵢ^{(j)} in equations (30), (33), (37):

$${α}_{1}^{( 0 )} = \frac{{σ}_{pos}^{( 0 )} \vert {θ}_{1}^{( 0 ) , umlim} \vert}{{σ}_{pos}^{( 0 )} \vert {θ}_{1}^{( 0 ) , unlim} \vert + {\sum }_{l = 1}^{N} {σ}_{pos}^{( l )} \sqrt{{( {θ}_{2}^{( l ) , umlim} )}^{2} + {( {θ}_{3}^{( l ) , unlim} )}^{2}}} , \\ {α}_{i}^{( j )} = \frac{{σ}_{pos}^{( j )} \vert {θ}_{1}^{( j ) , umlim} \vert}{{σ}_{pos}^{( 0 )} \vert {θ}_{1}^{( 0 ) , unlim} \vert + {\sum }_{l = 1}^{N} {σ}_{pos}^{( l )} \sqrt{{( {θ}_{2}^{( l ) , umlim} )}^{2} + {( {θ}_{3}^{( l ) , unlim} )}^{2}}} , \\ j \geq 1 , i = 2 , 3$$

$${β}_{1}^{( 0 )} = \frac{1}{\sqrt{{( j {Ωγ}_{pos} )}^{2} + {γ}_{spd}^{2}}} \frac{{f}_{i}^{( j )}}{{f}_{2}^{( j )} + {f}_{3}^{( j )}} \frac{{σ}_{spd}^{( 0 )} \vert {\dot{θ}}_{1}^{( 0 ) , umlim} \vert}{{σ}_{spd}^{( 0 )} \vert {\dot{θ}}_{1}^{( 0 ) , unlim} \vert + {\sum }_{l = 1}^{N} {σ}_{spd}^{( l )} ( {f}_{2}^{( l )} + {f}_{3}^{( l )} )} , \\ {β}_{i}^{( j )} = \frac{1}{\sqrt{{( j {Ωγ}_{pos} )}^{2} + {γ}_{spd}^{2}}} \frac{{f}_{i}^{( j )}}{{f}_{2}^{( j )} + {f}_{3}^{( j )}} \frac{{σ}_{spd}^{( j )} ( {f}_{2}^{( j )} + {f}_{3}^{( j )} )}{{σ}_{spd}^{( 0 )} \vert {\dot{θ}}_{1}^{( 0 ) , unlim} \vert + {\sum }_{l = 1}^{N} {σ}_{spd}^{( l )} ( {f}_{2}^{( l )} + {f}_{3}^{( l )} )} , \\ j \geq 1 , i = 2 , 3$$

$${γ}_{1}^{( 0 )} = \frac{\frac{{g}_{i}^{( j )}}{{g}_{2}^{( j )} + {g}_{3}^{( j )}}}{\sqrt{{( {γ}_{acc} + {( jΩ )}^{2} {γ}_{pos} )}^{2} + {( 2 {jΩγ}_{spd} + j \dot{Ω} {γ}_{pos} )}^{2}}} \frac{{σ}_{acc}^{( 0 )} \vert {\ddot{θ}}_{1}^{( 0 ) , umlim} \vert}{{σ}_{acc}^{( 0 )} \vert {\ddot{θ}}_{1}^{( 0 ) , unlim} \vert + {\sum }_{l = 1}^{N} {σ}_{acc}^{( l )} ( {g}_{2}^{( l )} + {g}_{3}^{( l )} )} , \\ {γ}_{i}^{( j )} = \frac{\frac{{g}_{i}^{( j )}}{{g}_{2}^{( j )} + {g}_{3}^{( j )}}}{\sqrt{{( {γ}_{acc} + {( jΩ )}^{2} {γ}_{pos} )}^{2} + {( 2 {jΩγ}_{spd} + j \dot{Ω} {γ}_{pos} )}^{2}}} \frac{{σ}_{acc}^{( j )} ( {g}_{2}^{( j )} + {g}_{3}^{( j )} )}{{σ}_{acc}^{( 0 )} \vert {\ddot{θ}}_{1}^{( 0 ) , unlim} \vert + {\sum }_{l = 1}^{N} {σ}_{acc}^{( l )} ( {g}_{2}^{( l )} + {g}_{3}^{( l )} )} .$$

The derivations above have been performed explicitly for IPC controllers, but are readily applicable to DBC controllers as well. The only difference is that the CPC controller no longer affects the constraints, so the inequalities in (22) will take the form

θ^{rest}(k)\dot{=}max{0, min{θₘₐₓ, −θₘᵢₙ}},

\dot{θ}^{rest}(k)\dot{=}max{0, min{\dot{θ}ₘₐₓ, −\dot{θ}ₘᵢₙ}},

\ddot{θ}^{rest}(k)\dot{=}max{0, min{\ddot{θ}ₘₐₓ, −\ddot{θ}ₘᵢₙ}}.

Example of mmIPC

In this section a simple case study is considered for demonstration of the developed multi-mode anti-windup controller implementation. For that purpose, a model of the UpWind 5 MW wind turbine is used in simulation with the following features:
Wind turbine model: linearized aerodynamic model obtained with the software TURBU (98th order lumped model containing first 6 blade modes and 8 tower modes, with no edgewise blade deformation),
Wind turbulence: 42 blade element effective wind speeds (14 per blade), containing both stochastic (turbulence) and deterministic (shear, tower shadow) components.
Conventional control: collective blade pitch control for rotor speed regulation (PI structure with bandstop filters at the tower frequency and at 2.23 Hz, and low pass filter at 3 p) and generator torque control for power regulation (linearized gain, including same filters as CPC). An anti-windup implementation of the CPC controller is used (not presented in this report), in which the pitch angle is allowed to vary in the interval [0°,85°], its speed in [−2°/s, 2°/s], and its acceleration in [−3°/s², 3°/s²].
IPC: integral control (with tower, 3P and 6P bandstop filters) for 1 p blade load reduction, acting on the 1 p-modulated blade root bending moments (An anti-windup scheme is used for IPC controller as proposed above (for only 1 p control, i.e. N=1), and for total pitch constraints θₘᵢₙ=0°, θₘₐₓ=85°, \dot{θ}ₘₐₓ=−\dot{θ}ₘᵢₙ=8°, \ddot{θ}ₘₐₓ=−\ddot{θ}ₘᵢₙ=16°). The tunable parameters in the anti-windup scheme are chosen as: γₚₒₛ=4, γ_{spd}=1, γ_{acc}=8 (these values are different for the DBC controller, see below).
DBC: the static aerodynamic characteristics of two flaps per blade are modeled using the possibilities of TURBU for controlling the local twist angle of blade elements. DBC is used for reduction of 0 p, 1 p, 2 p and 3 p loads in the blade root moments. (Note that for 0 p, the 0 p blade load reduction control is applied to the deviations of the blade moments from the equilibrium value at which the linearized model is defined). The blade root moments are used as measurements. It can be shown that for flaps of length 10% from the local cord, which change their shape parabolically, the effect of 2° displacement of the flap can be approximated by 1° rotation of the whole blade element. Selecting the flap constraints as in [8] (±10° for the position, and ±40°/s for the velocity, and no acceleration constraint), we impose the following constraints on the blade element twist angles: ±5° for the position, ±20°/s for the velocity, and no acceleration constraint. The tunable parameters in the anti-windup scheme are chosen as: γₚₒₛ=1, γ_{spd}=2, γ_{acc}=8, and

| std | 0p | 1p | 2p | 3p |
|---|---|---|---|---|
| σₚₒₛ^{(j)} | 1 | 2.6 | 1.4 | 1.2 |
| σ_{spd}^{(j)} | 0.2 | 3.2 | 3.7 | 2.7 |
| σ_{acc}^{(j)} | 1.5 | 4.2 | 11.2 | 14 |

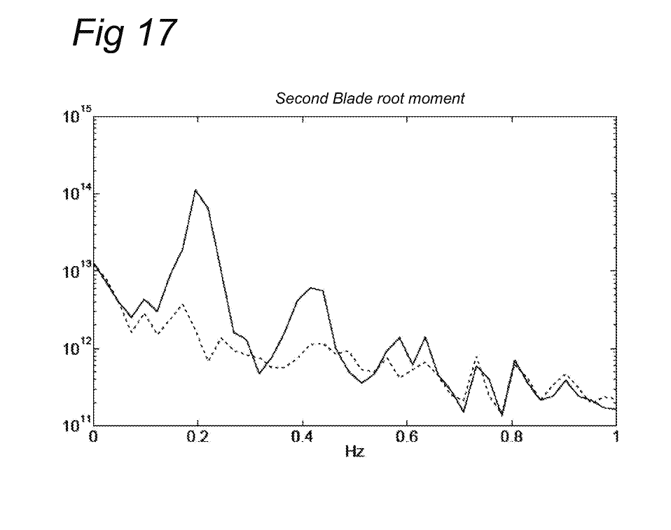

The angular positions and speeds of the two local blade twist signals, representing the two flaps as depicted in FIG. 16 (which shows angular positions (top) and speeds of blade portions (bottom) representing two flaps of the first blade.) are remaining within the limits throughout the whole simulation. FIG. 17 shows a spectrum of second blade root bending moment without IPC and DBC (red solid line), and with IPC and DBC (black dashed line).

The achieved load reduction using both IPC control (for 1 p reduction) and DBC control (for 0 p, 1 p, 2 p, and 3 p reduction) can be seen in FIG. 17 where the spectrum of the root bending moment of the second blade (black dashed line) is compared to the case of no load reduction control (red solid line). In terms of damage equivalent loads, a reduction of 48% is achieved.

Furthermore, it will be understood that the methods as described above may all be carried out by a computer arrangement comprising a processor for performing arithmetical operations, and a memory.

The processor may be arranged to read and execute programming lines stored in memory providing the processor with the functionality to perform the methods described above. The processor may be specially provided to perform one or more of the described embodiments, but may also be a central processor arranged to control the wind turbine as a whole and now being provided with additional functionality to perform one or more of the described embodiments.

For example, the invention may take the form of a computer program containing one or more sequences of machine-readable instructions describing a method as disclosed above, or a data storage medium (e.g. semiconductor memory, magnetic or optical disk) having such a computer program stored therein.

In Appendix A, the sequence of equations presented above is summarized in a list of equations.

### REFERENCES

[1] E. A. Bossanyi. Developments in individual blade pitch control. In Proceedings of “the Science of Making Torque from Wind” Conference, pages 486-497, 2004.

[2] E. A. Bossanyi. The design of closed loop controllers for wind turbines. Wind Energy, 3:149-163, 2000.

[3] E. A. Bossanyi. Individual blade pitch control for load reduction. Wind Energy, 6:1919-128, 2003.

[4] E. A. Bossanyi. Wind turbine control for load reduction. Wind Energy, 6:229-244, 2003.

[5] M. Geyler and P. Caselitz. Individual blade pitch control design for load reduction on large wind turbines. In Proceeding of the European Wind Energy Conference, pages 82-86, Milan, Italy, 2007.

[6] G. Goodwin, F. Graebe, and M. Salgado. Control System Design. Prentice Hall, Upper Saddle River, N.J., 2001.

[7] B. S. Kallesce. A low-order model for analyzing effects of blade fatigue load control. Wind Energy, 9:421-436, 2006.

[8] S. Kanev and T. van Engelen. Wind turbine extreme gust control. Technical Report ECN-E-08-069, ECN Wind Energy, 2008. http://www.ecn.nUpublicaties/default.aspx?nr=ECN-E--08-069.

[9] E. L. van der Hooft, P. Schaak, and T. G. van Engelen. Wind turbine control algorithms. Technical Report ECN-C-03-111, Energy Research Center of the Netherlands (ECN), 2003. DOWEC-F1W1-EH-03-094/0.

[10] T. van Engelen. Design model and load reduction assessment for multi-rotational mode individual pitch control (higher harmonics control). In Proceedings of the European Wind Energy Conference, Athens, Greece, 2006. http://www.ecn.n1/publicaties/defaultaspx?nr=ECN-RX--06-068.

[11] T. van Engelen. Control design based on aero-hydro-servo-elastic linear models from TURBU (ECN). In Proceeding of the European Wind Energy Conference, Milan, Italy, 2007.

[12] T. van Engelen and P. Schaak. Oblique inflow model for assessing wind turbine controllers. In Proceedings of the 2nd Conference on The Science of Making Torque From Wind, Denmark, 2007.

[13] K. Zhou and J. Doyle. Essentials of Robust Control. Prentice-Hall, 1998.

[14] Lackner, M. and G. van Kuik (2009): A Comparison of Smart Rotor Control Approaches Using Trailing Edge Flaps and Individual Pitch Control. Wind Energy (on-line publication).

[15] van Wingerden, J., T. Hulskamp, T. Barlas, B. Marrant, G. van Kuik, D. P. Molenaar and M. Verhaegen (2008): On the proof of concept of a “Smart” wind turbine rotor blade for load alleviation. Wind Energy, 11(3):265-280.

### APPENDIX

### List of Equations

### Apparatus and Method for Individual Pitch Control in a Wind Turbine

$$\begin{matrix}\dot{x} ( t ) = A ( ψ , p ) x ( t ) + B ( ψ , p ) θ ( t ) + E ( ψ , p ) w ( t ) \\ {M}_{z} ( t ) = C ( ψ , p ) x ( t ) + D ( ψ , p ) θ ( t ) + F ( ψ , p ) w ( t ) \\ {M}_{z} = {[ \begin{matrix}{M}_{{z}_{1}} ( t ) & {M}_{{z}_{2}} ( t ) & {M}_{{z}_{3}} ( t )\end{matrix} ]}^{T} , \\ θ = {[ \begin{matrix}{θ}_{1} ( t ) & {θ}_{2} ( t ) & {θ}_{3} ( t )\end{matrix} ]}^{T} , \\ w = {[ \begin{matrix}{w}_{1} ( t ) & {w}_{2} ( t ) & {w}_{3} ( t )\end{matrix} ]}^{T} & ( 1 ) \\ {T}_{D} ( ψ ) = [ \begin{matrix}\frac{1}{3} & \frac{1}{3} & \frac{1}{3} \\ \frac{2}{3} sin ( ψ ) & \frac{2}{3} sin ( ψ + \frac{2 π}{3} ) & \frac{2}{3} sin ( ψ + \frac{4 π}{3} ) \\ \frac{2}{3} cos ( ψ ) & \frac{2}{3} cos ( ψ + \frac{2 π}{3} ) & \frac{2}{3} cos ( ψ + \frac{4 π}{3} )\end{matrix} ] \\ [ \begin{matrix}{M}_{cm , 1} & {θ}_{cm , 1} & {w}_{cm , 1} \\ {M}_{cm , 2} & {θ}_{cm , 2} & {w}_{cm , 2} \\ {M}_{cm , 3} & {θ}_{cm , 3} & {w}_{cm , 3}\end{matrix} ] = {T}_{D} ( {ψ}_{k} ) [ \begin{matrix}{M}_{z , 1} & {θ}_{1} & {w}_{1} \\ {M}_{z , 2} & {θ}_{2} & {w}_{2} \\ {M}_{z , 3} & {θ}_{3} & {w}_{3}\end{matrix} ] . & ( 2 ) \\ {\dot{x}}_{cm} = {A}_{cm} ( p ) {x}_{cm} + {B}_{cm} ( p ) {θ}_{cm} + {E}_{cm} ( p ) {w}_{cm} \\ {M}_{cm} = {C}_{cm} ( p ) {x}_{cm} + {D}_{cm} ( p ) {θ}_{cm} + {F}_{cm} ( p ) {w}_{cm} \\ {T}_{M} ( ψ ) = [ \begin{matrix}1 & sin ( ψ ) & cos ( ψ ) \\ 1 & sin ( ψ + \frac{2 π}{3} ) & cos ( ψ + \frac{2 π}{3} ) \\ 1 & sin ( ψ + \frac{4 π}{3} ) & cos ( ψ + \frac{4 π}{3} )\end{matrix} ] . & ( 3 ) \\ {θ}_{cm , 2} = \frac{{k}_{2}}{s} {F}_{IPC} ( s ) {M}_{cm , 2} , \\ {θ}_{cm , 3} = \frac{{k}_{3}}{s} {F}_{IPC} ( s ) {M}_{cm , 3} , \\ {θ}_{i} = {θ}_{col} + sin ( ψ + \frac{( i - 1 ) 2 π}{3} ) {θ}_{cm , 2} + cos ( ψ + \frac{( i - 1 ) 2 π}{3} ) {θ}_{cm , 3} \\ {L}_{j} ( s ) = \frac{{k}_{2}}{s} {F}_{IPC} ( s ) {T}_{j} ( s ) . \\ [ \begin{matrix}y \\ {M}_{cm , 23}\end{matrix} ] = {T}_{23}^{aug} [ \begin{matrix}{w}_{cm , 23} \\ {θ}_{cm , 23}\end{matrix} ] , {T}_{23}^{aug} = [ \begin{matrix}[ \begin{matrix}0 & {W}_{u} ( s )\end{matrix} ] \\ \frac{1}{s} {W}_{M} ( s ) {T}_{23} ( s ) \\ {T}_{23} ( s )\end{matrix} ] \\ {C}_{IPC}^{∞} = arg {min}_{K} {‖ F ( {T}_{23}^{aug} ( s ) , K ( s ) ) ‖}_{∞} , & ( 4 ) \\ {C}_{IPC} ( s ) = [ \begin{matrix}\frac{1}{s} & \\ & \frac{1}{s}\end{matrix} ] {C}_{IPC}^{∞} ( s ) . \\ {K}_{gs}^{l} = {T}_{23} ( 0 ) \cdot {( {T}_{23}^{l} ( 0 ) )}^{- 1} , l = 1 , 2 , … , L , \\ j = \{ l : l = 1 , … , L , {θ}_{col}^{l} \leq {θ}_{col} ( t ) \leq {θ}_{col}^{l + 1} \} , \\ {\tilde{C}}_{IPC} ( s ) = {C}_{IPC} ( s ) ( α ( t ) {K}_{gs}^{l + 1} + ( 1 - α ( t ) ) {K}_{gs}^{l} ) . \\ [ \begin{matrix}{M}_{sh , y} \\ {M}_{sh , z}\end{matrix} ] = \underbrace{[ \begin{matrix}- sin 0 & - sin \frac{2}{3} π & - sin \frac{4}{3} π \\ cos 0 & cos \frac{2}{3} π & cos \frac{4}{3} π\end{matrix} ]}_{{T}_{D}^{sh}} [ \begin{matrix}{M}_{z , 1} \\ {M}_{z , 2} \\ {M}_{z , 3}\end{matrix} ] . \\ [ \begin{matrix}{θ}_{bal , 1} \\ {θ}_{bal , 2} \\ {θ}_{bal , 3}\end{matrix} ] = {T}_{M}^{sh} [ \begin{matrix}{θ}_{sh , y} \\ {θ}_{sh , z}\end{matrix} ] , {T}_{M}^{sh} = \frac{2}{3} [ \begin{matrix}- sin 0 & cos 0 \\ - sin \frac{2}{3} π & cos \frac{2}{3} π \\ - sin \frac{4}{3} π & cos \frac{4}{3} π\end{matrix} ] , \\ [ \begin{matrix}{θ}_{sh , y} \\ {θ}_{sh , z}\end{matrix} ] = \frac{{c}_{0}}{s} \frac{1}{τ s + 1} [ \begin{matrix}{M}_{sh , y} \\ {M}_{sh , z}\end{matrix} ] , \\ {T}_{sh}^{cl} ( s ) = \frac{1}{1 + k \frac{{c}_{0}}{s} \frac{1}{τ s + 1}} = \frac{\frac{τ {s}^{2}}{{kc}_{0}} + \frac{s}{{kc}_{0}}}{\frac{τ {s}^{2}}{{kc}_{0}} + \frac{s}{{kc}_{0}} + 1} . \\ {T}_{sh}^{cl , desired} ( s ) = \frac{\frac{1}{{ω}^{2}} {s}^{2} + \frac{2 β}{{ω}_{0}} s}{\frac{1}{{ω}^{2}} {s}^{2} + \frac{2 β}{{ω}_{0}} s + 1} , \\ τ = \frac{{T}_{set}}{8} , {c}_{0} = \frac{2}{k {β}^{2} {T}_{set}} . & ( 5 ) \\ {θ}_{min} \leq {θ}_{i} \leq {θ}_{max} , \\ {\dot{θ}}_{min} \leq {\dot{θ}}_{i} \leq {\dot{θ}}_{max} , \\ {\ddot{θ}}_{min} \leq {\ddot{θ}}_{i} \leq {\ddot{θ}}_{max} , & ( 6 )\end{matrix}$$

$$\begin{matrix} {θ}_{min} \leq {θ}_{min}^{col} \leq {θ}_{col} \leq {θ}_{max}^{col} \leq {θ}_{max} \\ {\dot{θ}}_{min} \leq {\dot{θ}}_{min}^{col} \leq {\dot{θ}}_{col} \leq {\dot{θ}}_{max}^{col} \leq {\dot{θ}}_{max} \\ {\ddot{θ}}_{min} \leq {\ddot{θ}}_{min}^{col} \leq {\ddot{θ}}_{col} \leq {\ddot{θ}}_{max}^{col} \leq {\ddot{θ}}_{max} . \\ {θ}_{i} = {θ}_{col} + sin ( {ψ}_{i} ) {θ}_{cm , 2} + cos ( {ψ}_{i} ) {θ}_{cm , 3} , i = 1 , 2 , 3. \\ {θ}^{rest} \dot{=} max \{ 0 , min \{ {θ}_{max} - {θ}_{col} , {θ}_{col} - {θ}_{min} \} \} , \\ {\dot{θ}}^{rest} \dot{=} max \{ 0 , min \{ {\dot{θ}}_{max} - {\dot{θ}}_{col} , {\dot{θ}}_{col} - {\dot{θ}}_{min} \} \} , \\ {\ddot{θ}}^{rest} \dot{=} max \{ 0 , min \{ {\ddot{θ}}_{max} - {\ddot{θ}}_{col} , {\ddot{θ}}_{col} - {\ddot{θ}}_{min} \} \} , \\ J ( ψ , {θ}_{cm , 2} , {θ}_{cm , 3} ) \dot{=} sin ( ψ ) {θ}_{cm , 2} + cos ( ψ ) {θ}_{cm , 3} , & ( 7 ) \\ \vert [ \begin{matrix}J ( ψ , {θ}_{cm , 2} , {θ}_{cm , 3} ) \\ \dot{J} ( ψ , {θ}_{cm , 2} , {θ}_{cm , 3} ) \\ \ddot{J} ( ψ , {θ}_{cm , 2} , {θ}_{cm , 3} )\end{matrix} ] \vert \leq [ \begin{matrix}{θ}^{rest} \\ {\dot{θ}}^{rest} \\ {\ddot{θ}}^{rest}\end{matrix} ] . & ( 8 ) \\ \vert {θ}_{cm , j} \vert \leq {α}_{j} {θ}^{rest} , j = \{ 2 , 3 \} . \\ [ {max}_{ψ} J ( ψ , {θ}_{cm , 2} , {θ}_{cm , 3} ) ≡ \sqrt{( {θ}_{cm , 2}^{2} + {θ}_{cm , 3}^{2}} ] \leq {θ}^{rest} \sqrt{{α}_{2}^{2} + {α}_{3}^{2}} . \\ \frac{{α}_{2}}{{α}_{3}} = \frac{\vert {θ}_{cm , 2}^{unlim} \vert}{\vert {θ}_{cm , 3}^{unlim} \vert} . & ( 9 ) \\ {α}_{j} \dot{=} \frac{\vert {θ}_{cm , j}^{unlim} \vert}{\sqrt{{( {θ}_{cm , 2}^{unlim} )}^{2} + {( {θ}_{cm , 3}^{unlim} )}^{2}}} , j = \{ 2 , 3 \} , \\ \dot{J} ( ψ , {θ}_{cm , 2} , {θ}_{cm , 3} ) = {\dot{J}}_{2} ( ψ , {θ}_{cm , 2} ) + {\dot{J}}_{3} ( ψ , {θ}_{cm , 3} ) , \\ {\dot{J}}_{2} ( ψ , {θ}_{cm , 2} ) \dot{=} Ω cos ( ψ ) {θ}_{cm , 2} + sin ( ψ ) {\dot{θ}}_{cm , 2} , \\ {\dot{J}}_{3} ( ψ , {θ}_{cm , 3} ) \dot{=} - Ωsin ( ψ ) {θ}_{cm , 3} + cos ( ψ ) {\dot{θ}}_{cm , 3} . & ( 10 ) \\ \vert {\dot{J}}_{j} ( ψ , {θ}_{cm , j} ) \vert \leq {β}_{j} {\dot{θ}}^{rest} , j = \{ 2 , 3 \} , \\ {max}_{ψ} \dot{J} ( ψ , {θ}_{cm , 2} , {θ}_{cm , 3} ) = ( {β}_{2} + {β}_{3} ) {\dot{θ}}^{rest} , \\ \frac{{β}_{2}}{{β}_{3}} = \frac{\vert {θ}_{cm , 2}^{unlim} \vert}{\vert {θ}_{cm , 3}^{unlim} \vert} , & ( 11 ) \\ {β}_{j} \dot{=} \frac{\vert {θ}_{cm , j}^{unlim} \vert}{\vert {θ}_{cm , 2}^{unlim} \vert + \vert {θ}_{cm , 3}^{unlim} \vert} , j = \{ 2 , 3 \} . & ( 12 ) \\ \vert {θ}_{cm , j} \vert \leq {γ}_{pos} {\dot{θ}}_{j}^{rest} , \\ \vert {θ}_{cm , j} \vert \leq {γ}_{spd} {\dot{θ}}_{j}^{rest} . \\ {max}_{ψ} {\dot{J}}_{j} ( ψ , {θ}_{cm , j} ) = \sqrt{{( Ω {θ}_{cm , j} )}^{2} + {\dot{θ}}_{cm , j}^{2}} \leq {\dot{θ}}_{j}^{rest} \sqrt{{γ}_{pos}^{2} {Ω}^{2} + {γ}_{spd}^{2}} . & ( 13 ) \\ {\dot{θ}}_{j}^{rest} = \frac{{β}_{j} {\dot{θ}}^{rest}}{\sqrt{{γ}_{pos}^{2} {Ω}^{2} + {γ}_{spd}^{2}}} , \\ \ddot{J} ( ψ , {θ}_{cm , 2} , {θ}_{cm , 3} ) = {\ddot{J}}_{2} ( ψ , {θ}_{cm , 2} ) + {\ddot{J}}_{3} ( ψ , {θ}_{cm , 3} ) , \\ {\ddot{J}}_{2} ( ψ , {θ}_{cm , 2} ) \dot{=} ( {\ddot{θ}}_{cm , 2} - {Ω}^{2} {θ}_{cm , 2} ) sin ( ψ ) + ( 2 Ω {\dot{θ}}_{cm , 2} + \dot{Ω} {θ}_{cm , 2} ) cos ( ψ ) , \\ {\ddot{J}}_{3} ( ψ , {θ}_{cm , 3} ) \dot{=} ( {\ddot{θ}}_{cm , 3} - {Ω}^{2} {θ}_{cm , 3} ) cos ( ψ ) - ( 2 Ω {\dot{θ}}_{cm , 3} + \dot{Ω} {θ}_{cm , 3} ) sin ( ψ ) . & ( 14 ) \\ \vert {\ddot{J}}_{j} ( ψ , {θ}_{cm , j} ) \vert \leq {β}_{j} {\ddot{θ}}^{rest} , j = \{ 2 , 3 \} , & ( 15 ) \\ \vert {θ}_{cm , j} \vert \leq {γ}_{pos} {\ddot{θ}}_{j}^{rest} , \\ \vert {\dot{θ}}_{cm , j} \vert \leq {γ}_{spd} {\ddot{θ}}_{j}^{rest} , \\ \vert {\ddot{θ}}_{cm , j} \vert \leq {γ}_{acc} {\ddot{θ}}_{j}^{rest} . \\ {max}_{ψ} {\ddot{J}}_{j} ( ψ , {θ}_{cm , j} ) = \sqrt{{( {\ddot{θ}}_{cm , j} - {Ω}^{2} {θ}_{cm , j} )}^{2} + {( 2 Ω {\dot{θ}}_{cm , j} + \dot{Ω} {θ}_{cm , j} )}^{2}} \leq {\ddot{θ}}_{j}^{rest} \sqrt{{( {γ}_{acc} + {Ω}^{2} {γ}_{pos} )}^{2} + {( 2 Ω {γ}_{spd} + \dot{Ω} {γ}_{pos} )}^{2}} & ( 16 ) \\ {\ddot{θ}}_{j}^{rest} = \frac{{β}_{j} {\ddot{θ}}^{rest}}{\sqrt{{( {γ}_{acc} + {Ω}^{2} {γ}_{pos} )}^{2} + {( 2 Ω {γ}_{spd} + \dot{Ω} {g}_{pos} )}^{2}}} & ( 17 ) \\ \vert {θ}_{cm , j} ( k ) \vert \leq min \{ {α}_{j} {θ}^{rest} , {γ}_{pos} {\dot{θ}}_{j}^{rest} , {γ}_{pos} {\ddot{θ}}_{j}^{rest} \} & ( 18 ) \\ \vert {θ}_{cm , j} ( k ) - {θ}_{cm , j} ( k - 1 ) \vert \leq min \{ {t}_{s} {γ}_{spd} {\dot{θ}}_{j}^{rest} , {t}_{s} {γ}_{spd} {\ddot{θ}}_{j}^{rest} \} & ( 19 ) \\ \vert {θ}_{cm , j} ( k ) - 2 {θ}_{cm , j} ( k - 1 ) + {θ}_{cm , j} ( k - 2 ) \vert \leq {t}_{s}^{2} {γ}_{acc} {\ddot{θ}}_{j}^{rest} \\ {C}_{IPC} ( z ) = [ \begin{matrix}\frac{{t}_{s}}{1 - {z}^{- 1}} & \\ & \frac{{t}_{s}}{1 - {z}^{- 1}}\end{matrix} ] {C}_{IPC}^{∞} ( z ) , \\ {T}_{D}^{( n )} ( ψ ) = [ \begin{matrix}\frac{1}{3} & \frac{1}{3} & \frac{1}{3} \\ \frac{2}{3} sin ( n ψ ) & \frac{2}{3} sin ( n ( ψ + \frac{2 π}{3} ) ) & \frac{2}{3} sin ( n ( ψ + \frac{4 π}{3} ) ) \\ \frac{2}{3} cos ( n ψ ) & \frac{2}{3} cos ( n ( ψ + \frac{2 π}{3} ) ) & \frac{2}{3} cos ( n ( ψ + \frac{4 π}{3} ) )\end{matrix} ] , \\ {T}_{M}^{( n )} ( ψ ) = [ \begin{matrix}1 & sin ( n ψ ) & cos ( n ψ ) \\ 1 & sin ( n ( ψ + \frac{2 π}{3} ) ) & cos ( n ( ψ + \frac{2 π}{3} ) ) \\ 1 & sin ( n ( ψ + \frac{4 π}{3} ) ) & cos ( n ( ψ + \frac{4 π}{3} ) )\end{matrix} ] . & ( 20 )\end{matrix}$$

$$\begin{matrix} {θ}_{min} \leq {θ}_{min}^{col} \leq {θ}_{col} \leq {θ}_{max}^{col} \leq {θ}_{max} \\ {\dot{θ}}_{min} \leq {\dot{θ}}_{min}^{col} \leq {\dot{θ}}_{col} \leq {\dot{θ}}_{max}^{col} \leq {\dot{θ}}_{max} \\ {\ddot{θ}}_{min} \leq {\ddot{θ}}_{min}^{col} \leq {\ddot{θ}}_{col} \leq {\ddot{θ}}_{max}^{col} \leq {\ddot{θ}}_{max} . & ( 21 ) \\ {θ}^{rest} ( k ) \dot{=} max \{ 0 , min \{ {θ}_{max} - {θ}_{col} ( k ) , {θ}_{col} ( k ) - {θ}_{min} \} \} , \\ {\dot{θ}}^{rest} ( k ) \dot{=} max \{ 0 , min \{ {\dot{θ}}_{max} - {\dot{θ}}_{col} ( k ) , {\dot{θ}}_{col} ( k ) - {\dot{θ}}_{min} \} \} , \\ {\ddot{θ}}^{rest} ( k ) \dot{=} max \{ 0 , min \{ {\ddot{θ}}_{max} - {\ddot{θ}}_{col} ( k ) , {\ddot{θ}}_{col} ( k ) - {\ddot{θ}}_{min} \} \} , & ( 22 ) \\ {σ}_{pos}^{( j )} = \frac{1}{3} {\sum }_{i = 1}^{3} std ( {\tilde{θ}}_{i}^{( j )} ) , \\ {σ}_{spd}^{( j )} = \frac{1}{3} {\sum }_{i = 1}^{3} std ( \frac{d}{d t} {\tilde{θ}}_{i}^{( j )} ) , \\ {σ}_{acc}^{( j )} = \frac{1}{3} {\sum }_{i = 1}^{3} std ( \frac{{d}^{2}}{d {t}^{2}} {\tilde{θ}}_{i}^{( j )} ) . \\ {θ}_{i} = {θ}_{col} + {\sum }_{j = 1}^{N} {\underbrace{sin [ j ( ψ + \frac{2 π ( i - 1 )}{3} ) ] {θ}_{2}^{( j )} + cos [ j ( ψ + \frac{2 π ( i - 1 )}{3} ) ] {θ}_{3}^{( j )}}}_{{\tilde{θ}}_{i}^{( j )}} . \\ {θ}_{i}^{ipc} = {\sum }_{i = 1}^{N} {\tilde{θ}}_{i}^{( j )} , & ( 23 ) \\ \vert {θ}_{i}^{ipc} \vert \leq {θ}^{rest} ( k ) , \\ \vert {\dot{θ}}_{i}^{ipc} \vert \leq {\dot{θ}}^{rest} ( k ) , \\ \vert {\ddot{θ}}_{i}^{ipc} \vert \leq {\ddot{θ}}^{rest} ( k ) . & ( 24 ) \\ {max}_{ψ ∈ R} ( sin ( ψ ) a + cos ( ψ ) b ) = \sqrt{{a}^{2} + {b}^{2}} , ∀ a , b ∈ R . & ( 25 ) \\ \vert {θ}_{i}^{( j )} \vert \leq {α}_{i}^{( j )} {θ}^{rest} ( k ) , \\ {max}_{ψ} {\tilde{θ}}_{i}^{( j )} = \sqrt{{( {θ}_{2}^{( j )} )}^{2} + {( {θ}_{3}^{( j )} )}^{2}} , \\ {max}_{ψ} {θ}_{i}^{ipc} \leq {\sum }_{j = 1}^{N} \sqrt{{( {θ}_{2}^{( j )} )}^{2} + {( {θ}_{3}^{( j )} )}^{2}} . \\ {max}_{ψ} {θ}_{i}^{ipc} \leq {θ}^{rest} ( k ) {\sum }_{j = 1}^{N} \sqrt{{( {α}_{2}^{( j )} )}^{2} + {( {α}_{3}^{( j )} )}^{2}} . & ( 26 ) \\ {\sum }_{j = 1}^{N} \sqrt{{( {α}_{2}^{( j )} )}^{2} + {( {α}_{3}^{( j )} )}^{2}} = 1. & ( 27 ) \\ \sqrt{{( {α}_{2}^{( j )} )}^{2} + {( {α}_{3}^{( j )} )}^{2}} = \frac{{σ}_{pos}^{( j )} \sqrt{{( {θ}_{2}^{( j ) , umlim} )}^{2} + {( {θ}_{3}^{( j ) , umlim} )}^{2}}}{{\sum }_{l = 1}^{N} {σ}_{pos}^{( l )} \sqrt{{( {θ}_{2}^{( l ) , umlim} )}^{2} + {( {θ}_{3}^{( l ) , unlim} )}^{2}}} , & ( 28 ) \\ \frac{{α}_{2}^{( j )}}{{α}_{3}^{( j )}} = \frac{\vert {θ}_{2}^{( j ) , unlim} \vert}{\vert {θ}_{3}^{( j ) , unlim} \vert} . & ( 29 ) \\ {α}_{i}^{( j )} = \frac{{σ}_{pos}^{( j )} \vert {θ}_{i}^{( j ) , umlim} \vert}{{\sum }_{l = 1}^{N} {σ}_{pos}^{( l )} \sqrt{{( {θ}_{2}^{( l ) , umlim} )}^{2} + {( {θ}_{3}^{( l ) , unlim} )}^{2}}} . & ( 30 ) \\ \vert {θ}_{i}^{( j )} \vert \leq {γ}_{pos} {β}_{i}^{( j )} {\dot{θ}}^{rest} ( k ) , \\ \vert {\dot{θ}}_{i}^{( j )} \vert \leq {γ}_{spd} {β}_{i}^{( j )} {\dot{θ}}^{rest} ( k ) , \\ \frac{d}{d t} {θ}_{i}^{ipc} = {\sum }_{i = 1}^{N} \frac{d}{d t} {\tilde{θ}}_{i}^{( j )} , \\ \frac{d}{d t} {\tilde{θ}}_{i}^{( j )} = cos [ j ( ψ + \frac{2 π ( i - 1 )}{3} ) ] ( j Ω ) {θ}_{2}^{( j )} + sin [ j ( ψ + \frac{2 π ( i - 1 )}{3} ) ] {\dot{θ}}_{2}^{( j )} - sin [ j ( ψ + \frac{2 π ( i - 1 )}{3} ) ] ( j Ω ) {θ}_{3}^{( j )} + cos [ j ( ψ + \frac{2 π ( i - 1 )}{3} ) ] {\dot{θ}}_{3}^{( j )} \\ {max}_{ψ} \frac{d}{d t} {\tilde{θ}}_{i}^{( j )} \leq \sqrt{{( j {Ωθ}_{2}^{( j )} )}^{2} + {( {\dot{θ}}_{2}^{( j )} )}^{2}} + \sqrt{{( j {Ωθ}_{3}^{( j )} )}^{2} + {( {\dot{θ}}_{3}^{( j )} )}^{2}} \leq {\dot{θ}}^{rest} ( k ) ( {β}_{2}^{( j )} + {β}_{3}^{( j )} ) \sqrt{{( {jΩγ}_{pos} )}^{2} + {γ}_{spd}^{2}} . \\ {\sum }_{j = 1}^{N} ( {β}_{2}^{( j )} + {β}_{3}^{( j )} ) \sqrt{{( {jΩγ}_{pos} )}^{2} + {γ}_{spd}^{2}} = 1. \\ {β}_{2}^{( j )} + {β}_{3}^{( j )} = \frac{1}{\sqrt{{( j {Ωγ}_{pos} )}^{2} + {γ}_{spd}^{2}}} \frac{{σ}_{spd}^{( j )} ( {f}_{2}^{( j )} + {f}_{3}^{( j )} )}{{\sum }_{l = 1}^{N} {σ}_{spd}^{( l )} ( {f}_{2}^{( l )} + {f}_{3}^{( l )} )} , & ( 31 )\end{matrix}$$

$$\begin{matrix} {f}_{i}^{( j )} = \sqrt{{( jΩ {θ}_{i}^{( j ) , unlim} )}^{2} + {( {\dot{θ}}_{i}^{( j ) , unlim} )}^{2}} . \\ \frac{{β}_{2}^{( j )}}{{β}_{3}^{( j )}} = \frac{{f}_{2}^{( j )}}{{f}_{3}^{( j )}} . & ( 32 ) \\ {β}_{i}^{( j )} = \frac{1}{\sqrt{{( j {Ωγ}_{pos} )}^{2} + {γ}_{spd}^{2}}} \frac{{f}_{i}^{( j )}}{{f}_{2}^{( j )} + {f}_{3}^{( j )}} \frac{{σ}_{spd}^{( j )} ( {f}_{2}^{( j )} + {f}_{3}^{( j )} )}{{\sum }_{l = 1}^{N} {σ}_{spd}^{( l )} ( {f}_{2}^{( l )} + {f}_{3}^{( l )} )} , & ( 33 ) \\ \vert {θ}_{i}^{( j )} \vert \leq {γ}_{pos} {γ}_{i}^{( j )} {\ddot{θ}}^{rest} ( k ) , \\ \vert {\dot{θ}}_{i}^{( j )} \vert \leq {γ}_{spd} {γ}_{i}^{( j )} {\ddot{θ}}^{rest} ( k ) , \\ \vert {\ddot{θ}}_{i}^{( j )} \vert \leq {γ}_{acc} {γ}_{i}^{( j )} {\ddot{θ}}^{rest} ( k ) , & ( 34 ) \\ \frac{{d}^{2}}{d {t}^{2}} {θ}_{i}^{ipc} = {\sum }_{i = 1}^{N} \frac{{d}^{2}}{d {t}^{2}} {\tilde{θ}}_{i}^{( j )} , \\ \frac{{d}^{2}}{d {t}^{2}} {\tilde{θ}}_{i}^{( j )} = sin [ j ( ψ + \frac{2 π ( i - 1 )}{3} ) ] ( {\ddot{θ}}_{2}^{( j )} + {( j Ω )}^{2} {θ}_{2}^{( j )} ) + cos [ j ( ψ + \frac{2 π ( i - 1 )}{3} ) ] ( 2 j Ω {\dot{θ}}_{2}^{( j )} + j \dot{Ω} {θ}_{2}^{( j )} ) cos [ j ( ψ + \frac{2 π ( i - 1 )}{3} ) ] ( {\ddot{θ}}_{3}^{( j )} + {( j Ω )}^{2} {θ}_{3}^{( j )} ) - sin [ j ( ψ + \frac{2 π ( i - 1 )}{3} ) ] ( 2 j Ω {\dot{θ}}_{3}^{( j )} + j \dot{Ω} {θ}_{3}^{( j )} ) . \\ {max}_{ψ} \frac{{d}^{2}}{d {t}^{2}} {\tilde{θ}}_{i}^{( j )} \leq \sqrt{{( {\ddot{θ}}_{2}^{( j )} + {( j Ω )}^{2} {θ}_{2}^{( j )} )}^{2} + {( 2 j Ω {\dot{θ}}_{2}^{( j )} + j \dot{Ω} {θ}_{2}^{( j )} )}^{2}} + \sqrt{{( {\ddot{θ}}_{3}^{( j )} + {( j Ω )}^{2} {θ}_{3}^{( j )} )}^{2} + {( 2 j Ω {\dot{θ}}_{3}^{( j )} + j \dot{Ω} {θ}_{3}^{( j )} )}^{2}} \leq {\ddot{θ}}^{rest} ( k ) ( {γ}_{2}^{( j )} + {γ}_{3}^{( j )} ) \sqrt{{( {γ}_{acc} + {( jΩ )}^{2} {γ}_{pos} )}^{2} + {( 2 {jΩγ}_{spd} + j \dot{Ω} {γ}_{pos} )}^{2}} . & \\ {\sum }_{j = 1}^{N} ( {γ}_{2}^{( j )} + {γ}_{3}^{( j )} ) \sqrt{{( {γ}_{acc} + {( jΩ )}^{2} {γ}_{pos} )}^{2} + {( 2 {jΩγ}_{spd} + j \dot{Ω} {γ}_{pos} )}^{2}} = 1. & ( 35 ) \\ {g}_{i}^{( j )} = \sqrt{{( {\ddot{θ}}_{i}^{( j ) , unlim} + {( jΩ )}^{2} {θ}_{i}^{( j ) , umlim} )}^{2} + {( 2 j Ω {\dot{θ}}_{i}^{( j ) , unlim} + j \dot{Ω} {θ}_{i}^{( j ) , unlim} )}^{2}} , \\ {γ}_{2}^{( j )} + {γ}_{3}^{( j )} = \frac{1}{\sqrt{{( {γ}_{acc} + {( jΩ )}^{2} {γ}_{pos} )}^{2} + {( 2 {jΩγ}_{spd} + j \dot{Ω} {γ}_{pos} )}^{2}}} \frac{{σ}_{acc}^{( j )} ( {g}_{2}^{( j )} + {g}_{3}^{( j )} )}{{\sum }_{l = 1}^{N} {σ}_{acc}^{( l )} ( {g}_{2}^{( l )} + {g}_{3}^{( l )} )} . \\ \frac{{γ}_{2}^{( j )}}{{γ}_{3}^{( j )}} = \frac{{g}_{2}^{( j )}}{{g}_{3}^{( j )}} . & ( 36 )\end{matrix}$$

$$\begin{matrix}{γ}_{i}^{( j )} = \frac{1}{\sqrt{{( {γ}_{acc} + {( jΩ )}^{2} {γ}_{pos} )}^{2} + {( 2 {jΩγ}_{spd} + j \dot{Ω} {γ}_{pos} )}^{2}}} \frac{{g}_{i}^{( j )}}{{g}_{2}^{( j )} + {g}_{3}^{( j )}} \frac{{σ}_{acc}^{( j )} ( {g}_{2}^{( j )} + {g}_{3}^{( j )} )}{{\sum }_{l = 1}^{N} {σ}_{acc}^{( l )} ( {g}_{2}^{( l )} + {g}_{3}^{( l )} )} \\ \vert {θ}_{i}^{( j )} \vert \leq min \{ {α}_{i}^{( j )} {θ}^{rest} ( k ) , {γ}_{pos} {β}_{i}^{( j )} {\dot{θ}}^{rest} ( k ) , {γ}_{pos} {γ}_{i}^{( j )} {\ddot{θ}}^{rest} ( k ) \} , \\ \vert {\dot{θ}}_{i}^{( j )} \vert \leq min \{ {γ}_{spd} {β}_{i}^{( j )} {\dot{θ}}^{rest} ( k ) , {γ}_{spd} {γ}_{i}^{( j )} {\ddot{θ}}^{rest} ( k ) \} , \\ \vert {\ddot{θ}}_{i}^{( j )} \vert \leq {γ}_{acc} {γ}_{i}^{( j )} {\ddot{θ}}^{rest} ( k ) . & ( 37 ) \\ \vert {θ}_{i}^{( j )} ( k ) \vert \leq min \{ {α}_{i}^{( j )} {θ}^{rest} ( k ) , {γ}_{pos} {β}_{i}^{( j )} {\dot{θ}}^{rest} ( k ) , {γ}_{pos} {γ}_{i}^{( j )} {\ddot{θ}}^{rest} ( k ) \} & ( 38 ) \\ \vert {θ}_{i}^{( j )} ( k ) - {θ}_{i}^{( j )} ( k - 1 ) \vert \leq {t}_{s} min \{ {γ}_{spd} {β}_{i}^{( j )} {\dot{θ}}^{rest} ( k ) , {γ}_{spd} {γ}_{i}^{( j )} {\ddot{θ}}^{rest} ( k ) \} & ( 39 ) \\ \vert {θ}_{i}^{( j )} ( k ) - 2 {θ}_{i}^{( j )} ( k - 1 ) + {θ}_{i}^{( j )} ( k - 1 ) \vert \leq {t}_{s}^{2} {γ}_{acc} {γ}_{i}^{( j )} {\ddot{θ}}^{rest} ( k ) & ( 40 ) \\ {α}_{1}^{( 0 )} = \frac{{σ}_{pos}^{( 0 )} \vert {θ}_{1}^{( 0 ) , umlim} \vert}{{σ}_{pos}^{( 0 )} \vert {θ}_{1}^{( 0 ) , unlim} \vert + {\sum }_{l = 1}^{N} {σ}_{pos}^{( l )} \sqrt{{( {θ}_{2}^{( l ) , umlim} )}^{2} + {( {θ}_{3}^{( l ) , unlim} )}^{2}}} , \\ {α}_{i}^{( j )} = \frac{{σ}_{pos}^{( j )} \vert {θ}_{i}^{( j ) , umlim} \vert}{{σ}_{pos}^{( 0 )} \vert {θ}_{1}^{( 0 ) , unlim} \vert + {\sum }_{l = 1}^{N} {σ}_{pos}^{( l )} \sqrt{{( {θ}_{2}^{( l ) , umlim} )}^{2} + {( {θ}_{3}^{( l ) , unlim} )}^{2}}} , \\ j \geq 1 , i = 2 , 3 \\ {β}_{1}^{( 0 )} = \frac{1}{\sqrt{{( j {Ωγ}_{pos} )}^{2} + {γ}_{spd}^{2}}} \frac{{f}_{i}^{( j )}}{{f}_{2}^{( j )} + {f}_{3}^{( j )}} \frac{{σ}_{spd}^{( j )} \vert {\dot{θ}}_{1}^{( 0 ) , umlim} \vert}{{σ}_{spd}^{( 0 )} \vert {\dot{θ}}_{1}^{( 0 ) , unlim} \vert + {\sum }_{l = 1}^{N} {σ}_{spd}^{( l )} ( {f}_{2}^{( l )} + {f}_{3}^{( l )} )} , \\ {β}_{i}^{( j )} = \frac{1}{\sqrt{{( j {Ωγ}_{pos} )}^{2} + {γ}_{spd}^{2}}} \frac{{f}_{i}^{( j )}}{{f}_{2}^{( j )} + {f}_{3}^{( j )}} \frac{{σ}_{spd}^{( j )} ( {f}_{2}^{( j )} + {f}_{3}^{( j )} )}{{σ}_{spd}^{( 0 )} \vert {\dot{θ}}_{1}^{( 0 ) , unlim} \vert + {\sum }_{l = 1}^{N} {σ}_{spd}^{( l )} ( {f}_{2}^{( l )} + {f}_{3}^{( l )} )} , \\ j \geq 1 , i = 2 , 3 \\ {γ}_{1}^{( 0 )} = \frac{1}{\sqrt{{( {γ}_{acc} + {( jΩ )}^{2} {γ}_{pos} )}^{2} + {( 2 {jΩγ}_{spd} + j \dot{Ω} {γ}_{pos} )}^{2}}} \frac{{g}_{i}^{( j )}}{{g}_{2}^{( j )} + {g}_{3}^{( j )}} \frac{{σ}_{acc}^{( 0 )} \vert {\ddot{θ}}_{1}^{( 0 ) , umlim} \vert}{{σ}_{acc}^{( 0 )} \vert {\ddot{θ}}_{1}^{( 0 ) , unlim} \vert + {\sum }_{l = 1}^{N} {σ}_{acc}^{( l )} ( {g}_{2}^{( l )} + {g}_{3}^{( l )} )} , \\ {γ}_{i}^{( j )} = \frac{1}{\sqrt{{( {γ}_{acc} + {( jΩ )}^{2} {γ}_{pos} )}^{2} + {( 2 {jΩγ}_{spd} + j \dot{Ω} {γ}_{pos} )}^{2}}} \frac{{g}_{i}^{( j )}}{{g}_{2}^{( j )} + {g}_{3}^{( j )}} \frac{{σ}_{acc}^{( j )} ( {g}_{2}^{( j )} + {g}_{3}^{( j )} )}{{σ}_{acc}^{( 0 )} \vert {\ddot{θ}}_{1}^{( 0 ) , unlim} \vert + {\sum }_{l = 1}^{N} {σ}_{acc}^{( l )} ( {g}_{2}^{( l )} + {g}_{3}^{( l )} )} , \\ {θ}^{rest} ( k ) \dot{=} max \{ 0 , min \{ {θ}_{max} , - {θ}_{min} \} \} , \\ {\dot{θ}}^{rest} ( k ) \dot{=} max \{ 0 , min \{ {\dot{θ}}_{max} , - {\dot{θ}}_{min} \} \} , \\ {\ddot{θ}}^{rest} ( k ) \dot{=} max \{ 0 , min \{ {\ddot{θ}}_{max} , - {\ddot{θ}}_{min} \} \} . & \end{matrix}$$

1. Method for blade load reduction control of a rotor of a wind turbine, the rotor being equipped with a plurality of blades, a pitch angle of each blade being controllable by an associated actuator;
the method comprising:
measuring a rotor azimuth angle signal;
measuring mechanical load parameters on the rotor;
providing a collective pitch control CPC for a collective pitch angle setting of the blades based on a rotor speed, derived from the rotor azimuth angle signal;
providing an individual pitch control IPC, comprising in order:
a—transforming the measured mechanical load parameters from a rotational reference frame to a mechanical load on the rotor in a fixed reference frame;
b—in the fixed reference frame, determining, based on the mechanical load on the rotor, for reduction of the mechanical load, two multi-blade pitch angles;
c—in the fixed reference frame, correcting the two multi-blade pitch angles to corrected multi-blade pitch angles by using a constraint condition, the constraint condition defining actuator limitations for the actuator associated with each respective blade;
d—inversely transforming the corrected multi-blade pitch angles in the fixed reference frame to an individual pitch deviation angle for each blade in the rotational reference frame, each individual pitch deviation angle being relative to the collective pitch angle;
e—in the rotational reference frame, adding up for each blade, the respective individual pitch deviation angle to the collective pitch angle to form an individual pitch angle for each blade;
and
controlling the associated actuator for each blade to set a pitch of the respective blade to the individual pitch angle for the respective blade.

2. Method according to claim 1, wherein the actuator limitation is selected from at least one from a group comprising a pitch position interval ranging from a minimum pitch angle to a maximum pitch angle of the blade, a pitch adaptation speed interval ranging from a minimum pitch adaptation speed to a maximum pitch adaptation speed and a pitch adaptation acceleration interval ranging from a minimum adaptation acceleration to a maximum adaptation acceleration for each blade.

3. Method according to claim 2, wherein a maximal individual pitch deviation angle is the maximum of a zero value and the minimum of a difference between the maximum pitch angle and the collective pitch angle and of a difference between the collective pitch angle and the minimum pitch angle.

4. Method according to claim 2, wherein a maximal adaptation speed of the individual pitch deviation angle is the maximum of a zero value and the minimum of a difference between the maximum pitch adaptation speed and an adaptation speed of the collective pitch angle and of a difference between the adaptation speed of the collective pitch angle and the minimum pitch adaptation speed.

5. Method according to claim 2, wherein a maximal adaptation acceleration of the individual pitch deviation angle is the maximum of a zero value and the minimum of a difference between the maximum pitch adaptation acceleration and an adaptation acceleration of the collective pitch angle and of a difference between the adaptation acceleration of the collective pitch angle and the minimum pitch adaptation acceleration.

6. Method according to claim 1, wherein measuring mechanical load parameters on the rotor comprises:
measuring a mechanical load parameter on each individual blade.

7. Method according to claim 1, wherein measuring mechanical load parameters on the rotor comprises:
measuring tilt and yaw mechanical load parameters on the rotor shaft.

8. Method according to claim 1, wherein said transforming the measured mechanical load parameters from the rotational reference frame to the mechanical load on the rotor in the fixed reference frame, comprises applying a Coleman demodulation on the measured mechanical load parameters.

9. Method according to claim 8, wherein the Coleman demodulation is so arranged that the measured mechanical load parameters measured in the rotational reference frame at a rotational frequency 1 p of the rotor are transformed to the mechanical load on the rotor in the fixed reference frame as a static 0 p mechanical load.

10. Method according to claim 1, wherein an absolute value of a multi-blade pitch angle is either equal to or smaller than a minimum selected from a group of three values, derived from the maximal individual pitch deviation angle, the maximal adaptation speed of the individual pitch deviation angle, and the maximal adaptation acceleration of the individual pitch deviation angle.

11. Method according to claim 1, wherein an absolute value of the adaptation speed of a multi-blade pitch angle is either equal to or smaller than a minimum selected from a group of two values, derived from the maximal adaptation speed of the individual pitch deviation angle, and the maximal adaptation acceleration of the individual pitch deviation angle.

12. Method according to claim 1, wherein an absolute value of the adaptation acceleration of a multi-blade pitch angle is either equal to or smaller than a value, derived from the maximal adaptation acceleration of the individual pitch deviation angle.

13. Method according to claim 1, wherein said inversely transforming the corrected multi-blade pitch angles in the fixed reference frame to an individual pitch deviation angle for each blade in the rotational reference frame comprises applying an inverse Coleman transformation.

14. Method according to claim 13, wherein the inverse Coleman demodulation is so arranged that the static 0 p component of the corrected multi-blade pitch angle in the fixed reference frame is transformed to the individual pitch deviation angle in the rotational reference frame at the rotational frequency 1 p.

15. Method according to claim 9, wherein the method comprises:
measuring mechanical load parameters on the rotor;
providing at least one further individual pitch control IPC, comprising:
f—providing a further transformation of the measured mechanical load parameters from a rotational reference frame to a further mechanical load on the rotor in a transformed reference frame;
g—in the transformed reference frame, determining, based on the further mechanical load, for reduction of the further mechanical load, two further multi-blade pitch angles;
h—in the transformed reference frame, correcting each further multi-blade pitch angle to a further corrected multi-blade pitch angle by using a constraint condition, the constraint condition defining actuator limitations for the actuator associated with each respective blade;
i—inversely transforming the further corrected multi-blade pitch deviation angle in the transformed reference frame to a further individual pitch deviation angle in the rotational reference frame, each further individual pitch deviation angle being relative to the collective pitch angle;
j—adding up for each blade, the respective further individual pitch deviation angle to the collective pitch angle to form an individual pitch angle for each blade in the rotational reference frame;

16. Method according to claim 15, wherein said further transformation of the measured mechanical load parameters from the rotational reference frame to a further mechanical load on the rotor in the transformed reference frame comprises applying a further Coleman demodulation on the measured mechanical load parameters; the further Coleman demodulation being so arranged that the measured mechanical load parameters measured in the rotational reference frame at a multiple of the rotational frequency 1 p of the rotor are transformed to the further mechanical load on the rotor in the transformed reference frame.

17. Method according to claim 16, wherein said inversely transforming the further corrected multi-blade deviation angle in the transformed reference frame to the further individual pitch deviation angle in the rotational reference frame comprises applying a further inverse Coleman transformation;
the further inverse Coleman demodulation being so arranged that the further corrected multi-blade pitch angle in the transformed reference frame is transformed to the further individual pitch deviation angle in the rotational reference frame at the multiple of the rotational frequency 1 p.

18. Method according to claim 16, wherein the multiple of the rotational frequency 1 p of the rotor is a number n selected from the range n=2-10, for an n.p rotational frequency.

19. Method according to claim 15, wherein an absolute value of a further multi-blade pitch angle is either equal to or smaller than a minimum selected from a group of three values, derived from the maximal individual pitch deviation angle, the maximal adaptation speed of the individual pitch deviation angle, and the maximal adaptation acceleration of the individual pitch deviation angle.

20. Method according to claim 15, wherein an absolute value of the further adaptation speed of a multi-blade pitch angle is either equal to or smaller than a minimum selected from a group of two values, derived from the maximal adaptation speed of the individual pitch deviation angle, and the maximal adaptation acceleration of the individual pitch deviation angle.

21. Method according to claim 15, wherein an absolute value of the further adaptation acceleration of a multi-blade pitch angle is either equal to or smaller than a value, derived from the maximal adaptation acceleration of the individual pitch deviation angle.

22. Controller apparatus for blade load reduction control of a rotor of a wind turbine, the rotor being equipped with a plurality of blades, a pitch angle of each blade being controllable by an associated actuator;
comprising:
a first input for receiving a rotor azimuth angle signal;
a second input for receiving measuring mechanical load parameter signals on the rotor;
a collective pitch controller unit for a collective pitch angle setting of the blades based on the rotor speed derived from the measured rotor azimuth angle signal;
an individual pitch controller unit comprising:
a transformation unit for transforming the measured mechanical load parameter signals from a rotational reference frame to a mechanical load signal on the rotor in a fixed reference frame;
a processing unit arranged for:
determining, based on the mechanical load signal on the rotor in the fixed reference frame, for reduction of the mechanical load, two multi-blade pitch angles;
the processing unit further arranged for correcting each multi-blade pitch angle to a corrected multi-blade pitch angle by using a constraint condition, the constraint condition defining actuator limitations for the actuator associated with each respective blade;
an inverse transformation unit arranged for inversely transforming the corrected multi-blade pitch angle in the fixed reference frame to a individual pitch deviation angle in the rotational reference frame, each individual pitch deviation angle being relative to the collective pitch angle;
an output arranged for:
adding up for each blade, the respective individual pitch deviation angle to the collective pitch angle to form an individual pitch angle for each blade and the controller apparatus further being arranged for controlling the associated actuator for each blade to set a pitch of the respective blade to the individual pitch angle for the respective blade.

23. Controller apparatus for blade load reduction control of a rotor of a wind turbine, the rotor being equipped with a plurality of blades, a pitch angle of each blade being controllable by an associated actuator; arranged for use according to the method of claim 1.
